(19) United States
(12) Patent Application Publication
(10) Pub. No.: US 2025/0245431 A1
(43) Pub. Date: Jul. 31, 2025

(54) SLANG USAGE DETECTION AND MITIGATION FOR LARGE LANGUAGE MODELS

(71) Applicant: Intuit, Inc., Mountain View, CA (US)

(72) Inventors: Tharathorn RIMCHALA, San Francisco, CA (US); Debasish DAS, San Jose, CA (US)

(21) Appl. No.: 18/424,572

(22) Filed: Jan. 26, 2024

(51) Int. Cl. G06F 40/284; G06F 40/289; G06F 40/40

(52) U.S. Cl. CPC G06F 40/284; G06F 40/289; G06F 40/40

(57) ABSTRACT

Certain aspects of the disclosure provide techniques for slang usage detection and mitigation. A method generally includes receiving an input sentence comprising a plurality of tokens; processing, with a first machine learning (ML) model trained for slang classification, the input sentence and thereby generating at least one of: a first classification output, for the input sentence, comprising a slang instance classification; or a second classification output for each of the plurality of tokens of the input sentence, at least one second classification output comprising a slang token classification; and based on the first classification output comprising the slang instance classification and/or the at least one second classification output comprising the slang token classification, processing with a second ML model trained for slang mitigation, the slang-containing input sentence to generate a slang-free output sentence, wherein an entailment score between the input sentence and the output sentence satisfies a threshold.

### BACKGROUND

### Field

Aspects of the present disclosure relate to slang usage detection and mitigation.

### Description of Related Art

A key long-term goal of artificial intelligence (AI) is to create machines capable of understanding and engaging in conversation using natural language. Dialogue systems, which can communicate with users in natural language, can assist users in completing a myriad of tasks, such as making reservations (e.g., task-oriented systems) and/or carrying out unstructured conversations on any topic (e.g., open-domain systems).

One example dialogue system is a large language model (LLM)-based system. LLMs have demonstrated notable performance for a variety of natural language processing (NLP) tasks. In particular, an LLM is a type of machine learning (ML) model that supports natural language-related tasks, such as generating text, analyzing sentiments, answering prompts (e.g., specific instructions and/or requests posed in natural language) in a conversational manner, translating text from one language to another, etc. LLMs makes it possible for software to “understand” typical human speech or written content as input into an LLM-based dialogue system and respond to it by, in some cases, human-understandable responses through natural language generation (NLG).

A popular LLM, which has gained much recent attention, is “ChatGPT,” produced by OpenAI®. Generative pre-trained transformer (GPT) models, such as ChatGPT, are a specific type of LLM based on a transformer architecture (e.g., architecture that uses an encoder-decoder structure and does not rely on recurrence and/or convolutions to generate an output), pre-trained in a generative and unsupervised manner (e.g., it learns from data without being given explicit instructions on what to learn). GPT models analyze prompts and predict the best possible responses, to these prompts, based on their understanding of the language. In particular, the GPT models rely on the knowledge they gain after their billions, or even trillions, of parameterized artificial neurons are trained on massive datasets.

While LLMs, such as ChatGPT, have shown success in a variety of NLP tasks and represent a transformative force in many industries by enabling developers to build conversation-driven applications, these models are not without limitation. For example, a technical challenge associated with LLMs is the ability to understand and generate informal language, such as slang. Slang is an informal, non-standard variety of speech characterized by newly coined and rapidly changing words and/or phrases. In certain settings, slang usage may negatively affect communications and thus result in poor user experience, lead to misunderstandings and/or gaps in communication, undermine credibility (e.g., language plays a significant role in conveying credibility), etc.

The flexible and ephemeral nature of slang poses a fundamental challenge when training LLMs to understand and generate slang. Specifically, slang is severely under-represented in standard lexical resources and may constitute only a small portion of text corpora used to train such models. Moreover, slang words/phrases especially those used in online communication and social media rapidly emerge and evolve over time. Unfortunately, an LLM is only as good as the underlying, available training data used to train the model; thus, due to the under-representation of slang in training data, the LLM may not adequately understand slang. Thus, the LLM may not be able to detect and/or mitigate the presence of slang in text received at the LLM and/or in text generated by the LLM.

This presents a technical problem as it may lead, in some cases, to the dissemination of slang-containing text to users and/or applications that rely on LLMs for content generation. As described above, slang usage may not be appropriate in certain contexts and have one or more negative outcomes. For example, a company may implement an LLM for automated online customer assistance. An inability of the LLM to understand, detect, and mitigate slang may result in the LLM generating natural language responses containing slang, and providing these responses to users communicating with the LLM. One or more users may find such responses inappropriate, unprofessional, misplaced, tasteless, and/or confusing, thereby negatively affecting the user's experience and, in some cases, undermining the credibility of the company from the user's perspective.

Another technical challenge associated with LLMs is the inability of LLMs to inherently mitigate slang usage when detected. For example, LLMs may not be configured or trained to remove, mask, or replace slang token(s) in text (e.g., where a token is an individual character, word, sub-word, phrase, or an even larger linguistic unit in text) with non-slang token(s) having similar meaning.

### SUMMARY

Certain aspects provide a method of training a machine learning (ML) model to detect slang usage, comprising: masking at least one token of a plurality of tokens for each training data instance of a plurality of training data instances to create a plurality of masked training data instances, wherein: the plurality of tokens for each training data instance in a first subset of the plurality of training data instances does not include at least one slang token of a plurality of slang tokens, and the plurality of tokens for each training data instance in a second subset of the plurality of training data instances includes the at least one slang token of the plurality of slang tokens; training the ML model, using a masked-language modeling head, to predict the at least one masked token for each of the plurality of masked training data instances using the plurality of training data instances and the plurality of masked training data instances; labeling each training data instance of the plurality of training data instances with at least one of a slang instance label, a non-slang instance label, one or more slang token labels, or one or more non-slang token labels to generate a plurality of labeled training data instances; and training the ML model, using a classification head, to: classify each training data instance of the plurality of labeled training data instances as one of a slang instance or a non-slang instance and thereby generate a classification output; or classify each token of the plurality of tokens for each training data instance of the plurality of labeled training data instances as one of a slang token or a non-slang token and thereby generate the classification output.

Certain aspects provide a method of training a ML model to mitigate slang usage, comprising: masking at least one token of a plurality of tokens for each first training data instance of a plurality of first training data instances to create a plurality of masked training data instances, wherein: the plurality of tokens for each first training data instance in a first subset of the plurality of first training data instances does not include at least one slang token of a plurality of slang tokens, and the plurality of tokens for each first training data instance in a second subset of the plurality of first training data instances includes the at least one slang token of the plurality of slang tokens; training the ML model, using a masked-language modeling head, to predict the at least one token masked for each of the plurality of masked training data instances using the plurality of first training data instances and the plurality of masked training data instances; obtaining a plurality of second training data instances, wherein each second training data instance comprises: a training input comprising a first plurality of tokens including the at least one slang token of the plurality of slang tokens; and a training output comprising a second plurality of tokens that do not include the at least one slang token of the plurality of slang tokens, wherein an entailment score between the training input and the training output of the respective second training data instance is greater than a threshold; and for each of the plurality of second training data instances, training the ML model, using a causal language modeling head, to predict the second plurality of tokens from the first plurality of tokens.

Certain aspects provide a method of slang detection and mitigation, comprising: receiving an input sentence comprising a plurality of tokens; and processing, with a first ML model trained for slang classification, the input sentence comprising the plurality of tokens and thereby generating at least one of: a first classification output for the input sentence, the first classification output comprising a slang instance classification; or a second classification output for each of the plurality of tokens of the input sentence, at least one second classification output comprising a slang token classification.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system configured for slang detection and/or mitigation.

FIGS. 2A-2D depict example dataset generation and labeling.

FIG. 3 depicts example masked language modeling pre-training to adapt a machine learning model to the slang domain.

FIG. 4A depicts example token-level slang usage classification training.

FIG. 4B depicts example sentence-level slang usage classification training.

FIG. 5 depicts example slang usage mitigation training.

FIG. 6 depicts an example system where content moderation techniques are implemented.

FIG. 7 depicts an example method of training a machine learning model to detect slang usage.

FIG. 8 depicts an example method of training a machine learning model to mitigate slang usage.

FIG. 9 depicts an example method of slang detection and mitigation.

FIG. 10 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

To address the shortcomings of LLMs with respect to understanding slang usage in text, some conventional approaches use pre-trained embeddings derived from slang-containing dataset(s), such as pre-trained Urban Dictionary® word embeddings, for ML model initialization. Word embeddings are vector representations of words (e.g., text) that allow words with similar meaning to have similar representations. Urban Dictionary word embeddings are example word embeddings learned from a corpus of text from Urban Dictionary, e.g., a crowd-sourced online English language dictionary for slang words and phrases not typically found in standard English dictionaries. Publicly available pre-trained ML model(s) may be used to process this corpus of text from Urban Dictionary and thereby learn embeddings for each slang word and/or phrase. Each embedding learned may capture some of the semantics of the input entry for each slang word and/or phrase by placing semantically similar slang words and/or phrases close together in the embedding space. The learned Urban Dictionary word embeddings may then be used to initialize an ML model for performing a slang detection as a binary classification (e.g., (1) a non-slang-class or (2) a slang class). The intended effect of using the word embeddings to initialize the ML model is to enable the ML model to better understand slang usage, to thereby improve text classification performed by the classifier model. A technical weakness of this approach, however, is the generation of the Urban Dictionary word embeddings using publicly available, pre-trained ML models. These models are pre-trained with web scale datasets with minimal slang representation. As such, reliance on these models for learning word embeddings for slang words and/or phrases may lead to poorly represented and/or inaccurate words and/or phrases.

An additional technical problem associated with ML models trained to perform slang detection using Urban Dictionary word embeddings, is their inability to perform token-level slang classification. As used herein, sentence-level and/or paragraph-level slang classification involves generating a single slang detection prediction for two or more tokens, while token-level slang classification involves generating a slang detection prediction for a single token. While sentence-level classification may result in a smaller inference response time than token-level classification for a plurality of one classification output, token-level classification also has some advantages over sentence-level classification. In particular, token-level classification may be useful at least for mitigation purposes to more efficiently identify a particular token that needs to be replaced, concealed, etc.

Accordingly, conventional approaches for slang usage detection and mitigation, such as using Urban Dictionary embeddings for slang NLP applications, are not effective and suffer from the aforementioned technical deficiencies.

Embodiments described herein overcome the aforementioned technical problems and improve upon the state of the art by introducing (1) a slang usage detection ML model configured for slang classification and (2) a slang usage mitigation ML model configured for performing slang mitigation to rephrase token(s) classified as containing slang content. The slang usage detection ML model may be an encoder only transformer architecture that includes one or more encoder layers and one or more classification layers. The slang usage mitigation ML model may be an encoder-decoder transformer architecture that includes one or more encoder layers and one or more decoder layers.

The encoder of each ML model may be adapted for slang-containing texts such that each model is able to better understand slang usage. For example, the encoder for each ML model may be pre-trained using masked pre-training methods, e.g., such as masked language modeling (MLM), where one or more tokens in a sentence, provided as input to the encoder, are masked such that the encoder learns to predict the masked tokens. Masking includes covering, removing, or concealing one or more tokens in the sentence. The sentences used for masked pre-training may be obtained and generated from publicly available slang dataset(s) including (1) slang tokens, (2) definition(s) corresponding to each of the slang tokens (e.g., where each definition does not include any slang tokens), and/or (3) example sentence(s) using each of the slang tokens. For example, an entry included in a public slang dataset may include an example slang token “FOMO,” accompanied with a definition of “a state of mental or emotional strain caused by the fear of missing out” and an example sentence of “The college student had concert FOMO.” An LLM may be used to generate example sentences, with one or more slang tokens and without one or more slang tokens, from one or more definitions and one or more example sentences included in the public slang datatset(s). Each of the generated sentences, the publicly available sentences, and the publicly available definitions, associated with various slang tokens, (e.g., each referred to herein as a “training data instance”) may be used for masked pre-training of the encoder for each ML model. For example, tokens masked for each training data instance may be non-slang tokens and/or slang tokens, such that the encoder for each ML model learns to understand and predict both slang and non-slang usage. As such, after pre-training, the encoder may be adapted for slang texts.

For the slang usage detection ML model, the pre-trained encoder is used to process an input sentence comprising a plurality of tokens and produce a continuous-valued representation vector, also referred to as an “embedding,” for each token in the input sentence. The embedding may be a context aware embedding that assigns each token in the input sentence a representation based on its context (e.g., the parts/tokens that precede or follow the specific token in the input sentence), thereby capturing the use of each token in the input sentence in context. The one or more classification layers of the slang usage detection ML model then take the embedding for each token of the input sentence (e.g., individually or together) as input and generate slang usage classification output. In some cases, the slang usage classification output is a sentence-level classification classifying the input sentence as slang or not (e.g., including slang content or not). In some cases, the slang usage classification output is a token-level classification classifying each token of the input sentence as slang or not (e.g., including slang content or not and/or being part of slang content or not). In some cases, token-level classification is used as an alternative to sentence-level classification where more granular classifications are desired. For example, instead of identifying multiple tokens as slang content, a single token among the tokens may be identified as slang content. This granularity of information may be useful for a user and/or another model or component to enable the user and/or the other model or component to know which specific token(s) comprise slang content such that mitigating action can be taken. In some other cases, sentence-level classification may be used instead of token-level classification, for example, to reduce inference response time (e.g., the time required to produce a classification output for the plurality of tokens). Reducing inference response time may be necessary in some cases to meet a response time service-level agreement (SLA). In some cases, the slang usage detection ML model is configured to generate both (1) a sentence-level classification output classifying the input sentence as including slang content or not and (2) one or more token-level classification outputs, where each token-level classification output classifies each token of the input sentence as slang or not (e.g., including slang content or not and/or being part of slang content or not)

Similar to the slang usage detection ML model, the encoder of the slang usage mitigation ML model may be used to process an input sentence, identified as including slang content, and produce a continuous representation, also referred to as an “embedding,” for each token in the input sentence. A decoder of the slang usage mitigation ML model uses this embedding generated for the slang input sentence (e.g., including slang content) to generate a non-slang output sentence (e.g., not including any slang content). In other words, the encoder-decoder transformer architecture of the slang usage mitigation ML model may be configured to rephrase slang text into non-slang text. The meaning of the generated output sentence may be entailed (e.g., may be inferred) from the input sentence. Entailment (also referred to as “semantic entailment,” “textual entailment,” or “natural language inferencing”) is a directional relation between fragments of text when one fragment in some sense implies the other fragment. More specifically, entailment tries to identify the relationship between the meanings of a pair of sentences. The identified relationship may be (1) “entailment” where the output sentence has a similar meaning as the input sentence, (2) “contradiction” where the output sentence is a sentence with a contradictory meaning, or (3) “neural” where the output sentence is a sentence with mostly the same lexical items as the input sentence but with a different meaning. For example, an entailment relationship may be identified between an input sentence “I bought these expensive designer dresses I've been eyeing-YOLO!” and an output sentence “I decided to purchase the expensive designer dresses I had been admiring, rationalizing that I should take advantage of the moment and live life to the fullest.” An ability of the ML model, described herein, to generate non-slang sentences from slang sentences helps to reduce the time required to produce a mitigation output for a plurality of tokens (e.g., instead of identifying slang token(s) from a plurality of tokens in the slang sentence and using the ML model to replace each of the identified token(s)).

Though embodiments herein describe the use of slang and/or non-slang sentences to train the ML models, in certain other embodiments, other slang and/or non-slang tokens, such as phrases, are used to train the ML models. Though embodiments herein describe the use of an ML model to predict sentence-level slang classifications for input sentences, in certain other embodiments, slang classifications may be predicted for other tokens that do not make up a sentence, for example, that are included in a phrase. Further, though embodiments herein describe the use of an ML model to predict an output sentence, not containing any slang tokens (e.g., a slang free sentence), from a slang-containing sentence, in some other embodiments, the ML model may be trained to predict any plurality of tokens, such as a non-slang phrase from a slang phrase instead.

In certain embodiments, the additional data instances generated for training the encoder of each ML model helps to overcome some of the technical problems of using ML models for slang detection and mitigation, for example, the limited amount of quantitative data available for training such ML models. In particular, the additional slang and non-slang data instances generated using the techniques described above help to increase the pool of available training data needed to train ML models for slang usage, given slang is under-represented in standard lexical resources. This additional data may provide additional example uses of slang and non-slang text that were not previously publicly available, thereby allowing the ML algorithms to learn and fine-tune their prediction, and help the ML models generalize better. Accordingly, the methods described herein represent a technical solution and improvement to the technical problem and limitation posed by existing ML techniques in which insufficient slang data is available to train reliable and generalizable models.

Further, the slang usage detection ML model described herein provides significant technical advantages over conventional solutions, such as improved slang usage detection accuracy and the ability to perform token-level slang usage classification for slang mitigation purposes. These technical effects overcome technical problems of low slang usage detection accuracy and limited detection capabilities in conventional approaches. For example, building the slang usage detection ML model on top of the pre-trained encoder adapted for slang-containing texts enables better understanding and thus detection of slang usage in texts. Further, the ability of the slang usage detection ML model described herein to perform token-level slang usage classification allows for specific slang token(s) to be identified. Additionally, the slang usage mitigation ML model described herein provides significant technical advantages over conventional solutions by, for example, providing a tool that is capable of rephrasing slang-containing text and generating non-slang-containing text, while maintaining a similar meaning as the slang-containing text.

### Example System for Training and Using ML Models for Slang Usage Detection and Mitigation

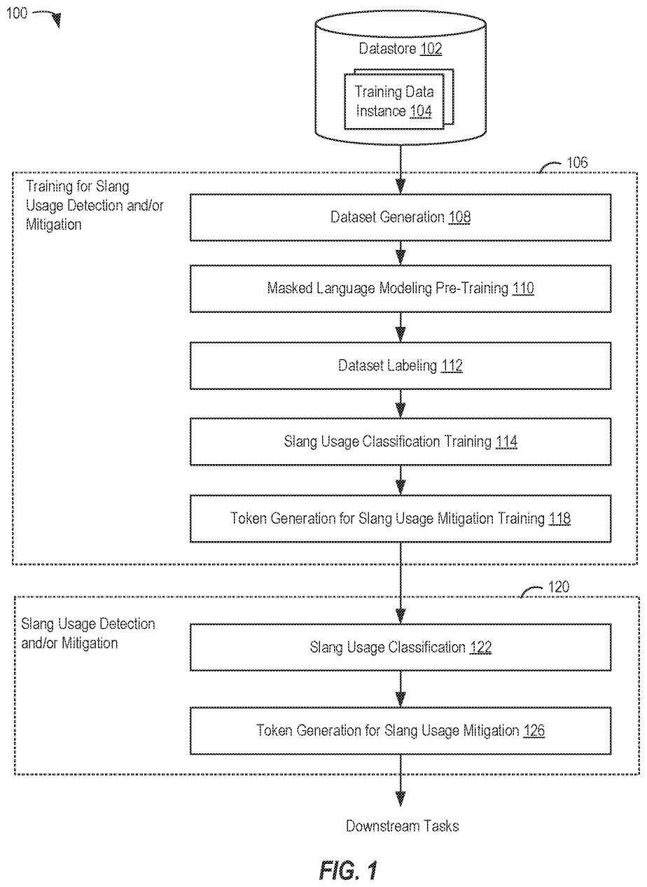

FIG. 1 depicts an example system 100 for training and using ML model(s) for slang usage detection, slang usage mitigation, or both. Slang usage detection includes detecting a type of language, slang, that is regarded as very informal and often not considered part of a standard vocabulary. Slang usage detection may be performed by a first ML model, also referred to herein as a slang usage detection ML model. The slang usage detection ML model may be an encoder only transformer architecture, such as, for example, a decoding-enhanced bidirectional encoder representations from transformers with disentangled attention (DeBERTa) model.

Slang usage mitigation includes rephrasing an input sentence (e.g., including two or more tokens), classified as including slang content, such that the rephrased sentence has a same meaning as the input sentence including the slang content, but does not include any slang content. Slang usage mitigation may be performed by a second ML model, also referred to herein as a slang usage mitigation ML model. The slang usage mitigation ML model may be an encoder-decoder transformer architecture.

As shown in FIG. 1, training ML models for slang usage detection and mitigation, at 106, includes dataset generation 108, MLM pre-training 110, dataset labeling 112, slang usage classification training 114, and token generation for slang usage mitigation training 118.

Dataset generation 108 includes (1) generating one or more training data instances and/or (2) generating one or more labels for existing training data instance(s) and/or generated training data instance(s). For example, training data instances 104, stored in datastore 102, may be obtained for training the ML models. Training data instances 104 may include training data instances from one or more publicly available datasets, such as Urban Dictionary®, Dictionary of American Regional English (DAREDS™), Green's Dictionary of Slang (GDoS™), and/or the like. One or more training data instances 104 may include a definition associated with a slang token obtained from one of the publicly available datasets. Although associated with a slang token, the definition may not include any slang tokens. By way of example, a training data instance 104 may include the definition “a state of mental or emotional strain caused by the fear of missing out” for the slang token “FOMO.” Other training data instances 104 may include an example sentence including at least one slang token obtained from one of the publicly available datasets. By way of example, a training data instance 104 may include the example sentence “The college student had concert FOMO,” which provides an example usage of the slang token “FOMO.” As such, a first subset of the training data instances 104 from the publicly available dataset(s) may not include any slang tokens, while a second subset of the training data instances 104 from the one or more publicly available dataset(s) may include at least one slang token.

As described above, slang-containing texts represent a minority of publicly available data. As such, to supplement training data instances 104 obtained from publicly available dataset(s), additional training data instances 104 may be generated. In particular, in certain embodiments, non-slang data instances (e.g., definitions not including any slang tokens) are used by an LLM to generate slang data instances, while slang data instances (e.g., example sentences including at least one slang token) are used by the LLM to generate non-slang data instances (e.g., example sentences not including any slang content/tokens). By way of example, training data instance 104 including the definition “a state of mental or emotional strain caused by the fear of missing out” for the slang token “FOMO” may be used to generate an additional training data instance 104, such as, example sentence “I heard about the birthday party and have major FOMO” including the slang token “FOMO.” As another example, training data instance 104 including the example sentence “The college student had concert FOMO” including the slang token “FOMO” may be used to generate an additional training data instance 104, such as, example sentence “The college student felt pervasive apprehension that others were having rewarding experiences without him because he did not attend the concert.” As such, the pool of training data instances 104, used to train ML models for slang usage detection and mitigation, may be increased to include additional slang data instance(s) and/or one or more non-slang data instance(s) with meanings similar to existing slang data instances. Slang data instance(s) may help to expose the ML models to additional uses of slang tokens to enable the ML models to better understand and detect slang usage. Further, non-slang data instance(s) may help the ML models learn alternative expressions for slang tokens without the use of such slang tokens. For example, the ML models may learn that “The college student felt pervasive apprehension that others were having rewarding experiences without him because he did not attend the concert” is an alternative way of saying “The college student had concert FOMO” such that use of the slang token “FOMO” may be avoided.

In certain embodiments, one or more techniques are used to help ensure that the generated training data instances 104 have an entailment score that satisfies a threshold. More specifically, an entailment model (e.g., an off-the-shelf entailment model) may be used to determine an entailment score (1) between an existing non-slang data instance 104 and a generated slang data instance 104 and/or (2) between an existing slang data instance 104 and a generated non-slang data instance 104. In other words, the entailment score may identify how similar a generated training data instance 104 to an existing training data instance 104. Only those generated training data instances 104 having an entailment score that satisfies a threshold may be kept, while those generated training data instances 104 having an entailment score that does not satisfy a threshold are discarded and not used for training. Specifically, a generated slang data instance 104 that does not satisfy the threshold may not accurately represent the slang token definition from which it is generated; thus, the use of the slang token in the generated slang data instance 104 may be incorrect. The slang data instance 104 may be discarded such that the ML models do not learn incorrect usage of the slang token. Similarly, a generated non-slang data instance 104 that does not satisfy the threshold may not accurately paraphrase an example sentence from which it is generated. This non-slang data instance 104 may be discarded such that the ML models do not learn an incorrect paraphrasing of an example sentence containing a slang token.

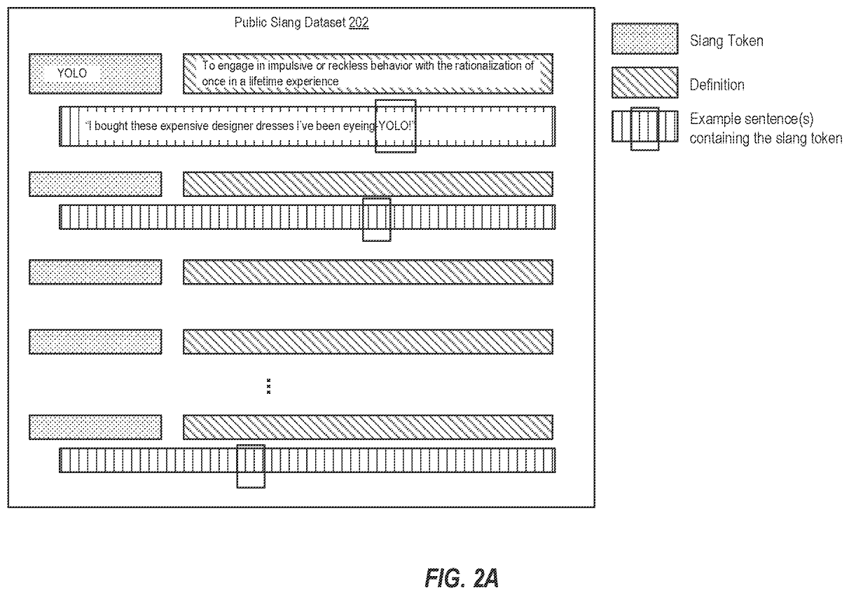

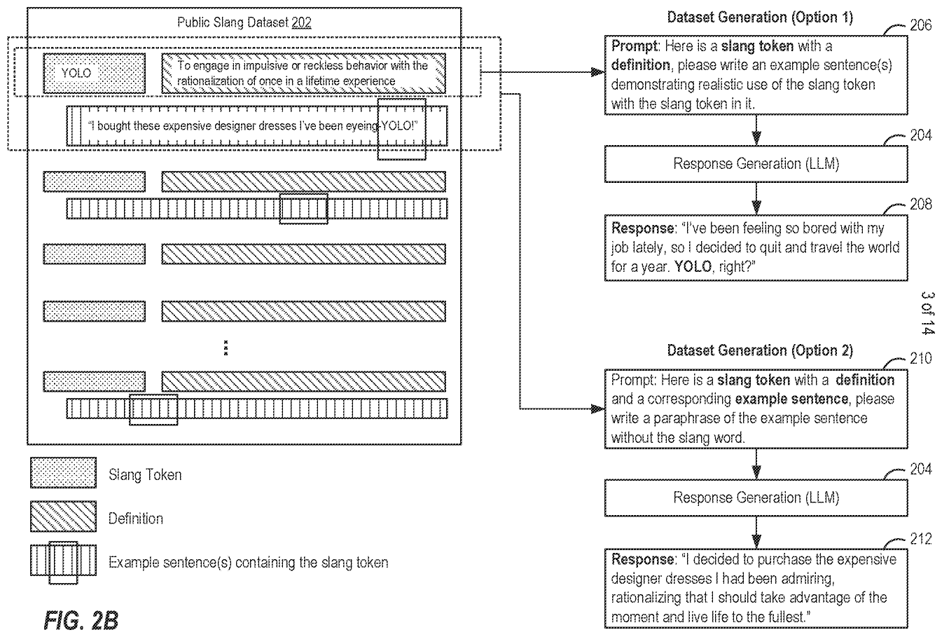

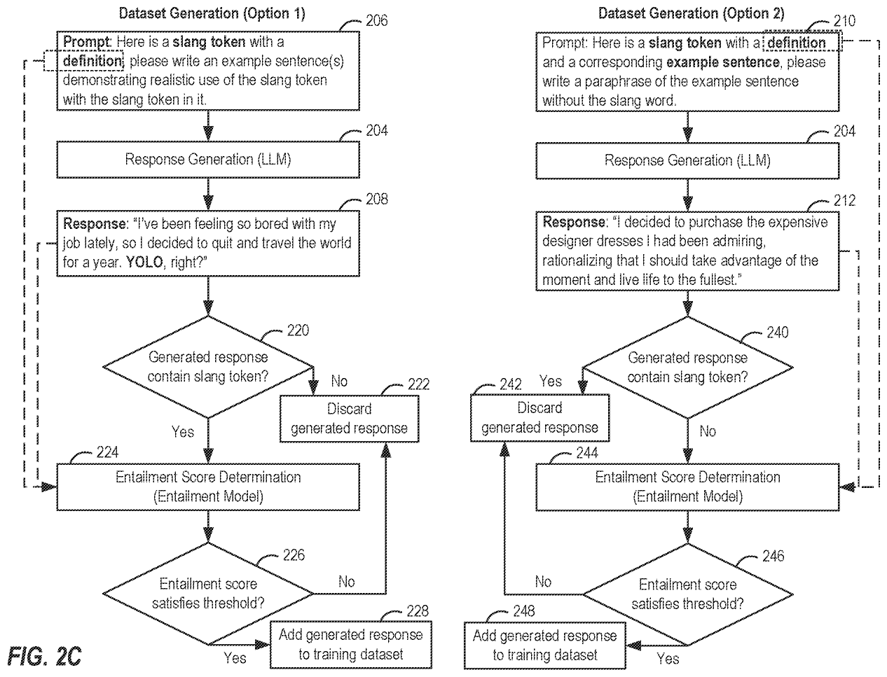

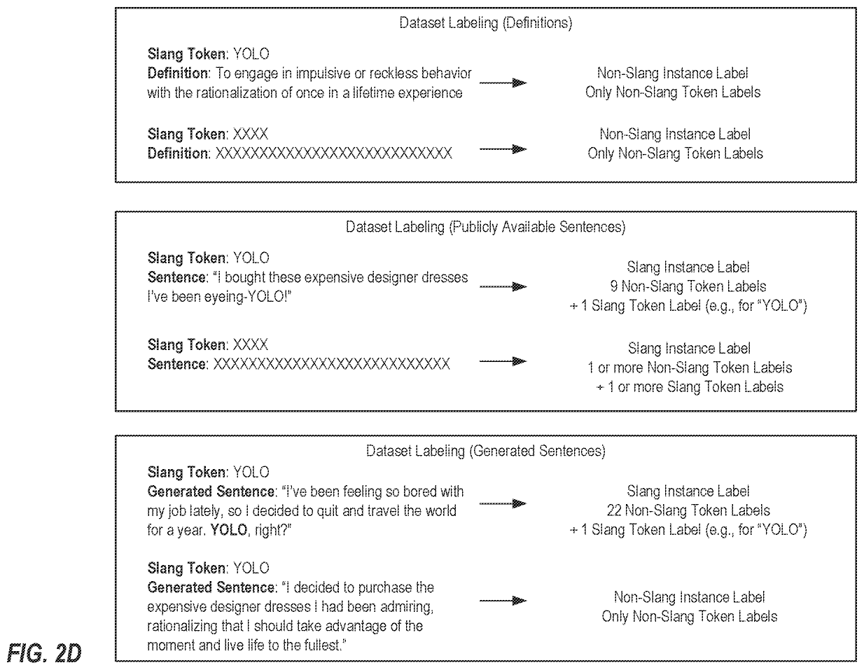

Additional details regarding dataset generation 108 are provided herein with respect to FIGS. 2A-2C.

MLM pre-training 110 (e.g., an unsupervised language modeling pre-training technique) may use the existing and/or generated training data instances 104 to train the slang usage detection ML model and the slang usage mitigation ML model to predict masked token(s) for each training data instance 104. The ML models may predict the masked token(s) for each training data instance 104 by gathering the context from the surrounding token(s) in a respective training data instance 104. For instance, one or more slang data instances 104 and one or more non-slang data instances 104 may be combined and used for training a transformer encoder of each ML model with a MLM head. The MLM head may be added to the encoder of each ML model to fine-tune each model for the slang domain. Specifically, the MLM head may be added such that MLM pre-training 110 can be performed. One or more tokens of each training data instance 104 may be masked and fed to one of the respective ML models such that each ML model learns to predict the masked token(s). The masked token(s), which the ML models predict, may be slang tokens and/or non-slang tokens. The model weight, for each ML model (e.g., one ML model for slang usage detection and one ML model for slang usage mitigation), is optimized using MLM objectives to adapt each ML model to the slang domain.

In some cases, only an encoder of the slang usage detection ML model is pre-trained using MLM techniques. This pre-trained encoder may be used in the slang usage detection ML model, and also, in some cases, re-used in the slang usage mitigation ML model. More specifically, the pre-trained encoder (e.g., without classification layer(s)) of the slang usage detection ML model may be re-used as an encoder in the encoder-decoder architecture of the slang usage mitigation ML model. As such, MLM pre-training 110 may only need to be performed once, for one encoder (e.g., used in two different ML models).

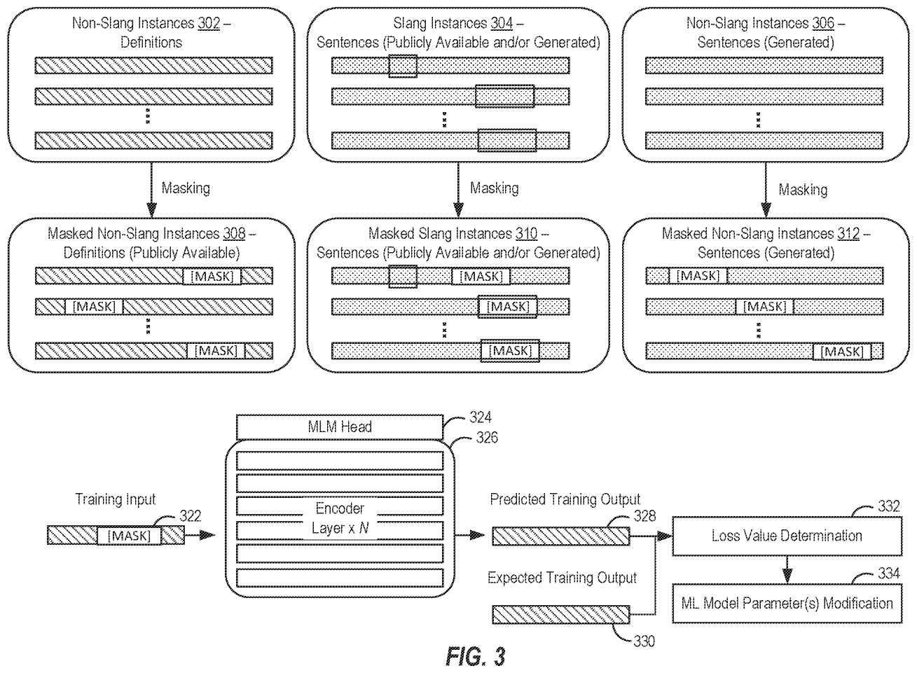

Additional details regarding MLM pre-training 110 are provided herein with respect to FIG. 3.

Dataset labeling 112 may include adding one or more meaningful and informative labels to each training data instance 104 (e.g., including existing and generated instances) to provide context such that the ML models can learn from it. For example, dataset labeling may include labeling each training data instance 104 with a first label indicating whether or not the training data instance includes slang. A training data instance 104 may be labeled with a slang instance label if the instance includes at least one slang token (e.g., referred to herein as “sentence-level slang usage classification”). Otherwise, the training data instance 104 may be labeled with a non-slang instance label. Further, dataset labeling may include labeling each token of each training data instance 104 with a second label indicating whether or not the token is slang (e.g., referred to herein as “token-level slang usage classification”). In particular, a token that is slang (e.g., includes slang content and/or is part of slang content based on a list of known slang tokens provided in corpora of text from the publicly available dataset(s)) may be given a slang token label, while a token that is not slang (e.g., does not include slang and/or is not part of slang content) may be given a non-slang token label. By way of example, the training data instance including the definition for slang token “FOMO,” e.g., “a state of mental or emotional strain caused by the fear of missing out” may be labeled with a non-slang instance label, while each of the fourteen tokens included in the definition are labeled with a non-slang token label.

Additional details regarding dataset labeling 112, including performing entailment checks, are provided herein with respect to FIG. 2D.

Sentence-level slang usage classification training 114 includes training the slang usage detection ML model for sentence-level or token-level slang usage classification. For example, the slang usage detection ML model may be trained to identify a plurality of tokens (e.g., an input sentence/a training data instance), provided as input to the ML model, as a slang or a non-slang instance (e.g., a slang or non-slang sentence). To train the ML model, each sentence-level classification predicted by the model may be compared to a sentence-level label associated with the input plurality of tokens (e.g., for one or more training data instances). In certain embodiments, modifying parameter(s) of the ML model is performed until all training data instances 104 have been used to train the ML model for sentence-level slang usage classification. In certain embodiments, modifying parameter(s) of the ML model is performed until desired training stopping criteria is achieved. One example of training stopping criteria includes convergence (e.g., further training may not lead to any significant loss reduction). Another example of training stopping criteria includes a number of training steps/epochs reaching pre-determined limit(s) and/or divergence (e.g., further training may cause over-fitting as diagnosable by increasing evaluation loss). Another example of training stopping criteria includes a number of contiguous training epochs during which training loss is not decreasing more than a threshold amount (e.g., patience). Alternatively, token-level slang usage classification training includes training the slang usage detection ML model for token-level slang usage classification. For example, the slang usage detection ML model may be trained to identify each token in a plurality of tokens (e.g., of a training data instance), provided as input to the ML model, as a slang or non-slang token. To train the ML model, each token-level classification predicted by the model may be compared to a token-level label associated with a respective token of the input plurality of tokens (e.g., for one or more training data instances). Similar to sentence-level slang usage classification training, for token-level slang usage classification training, various parameters may be modified for the ML model based on the comparison for each token of each training data instance.

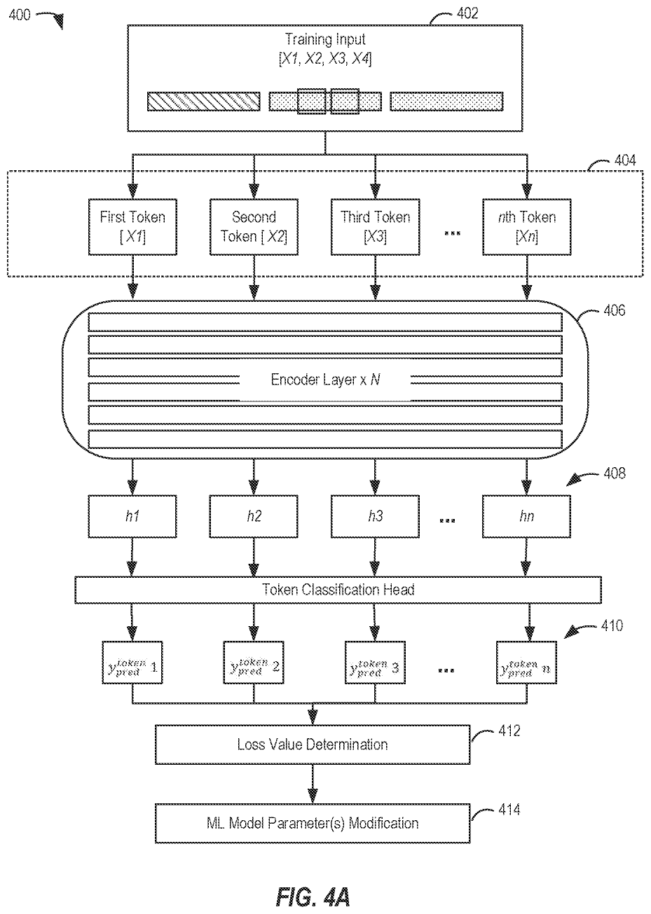

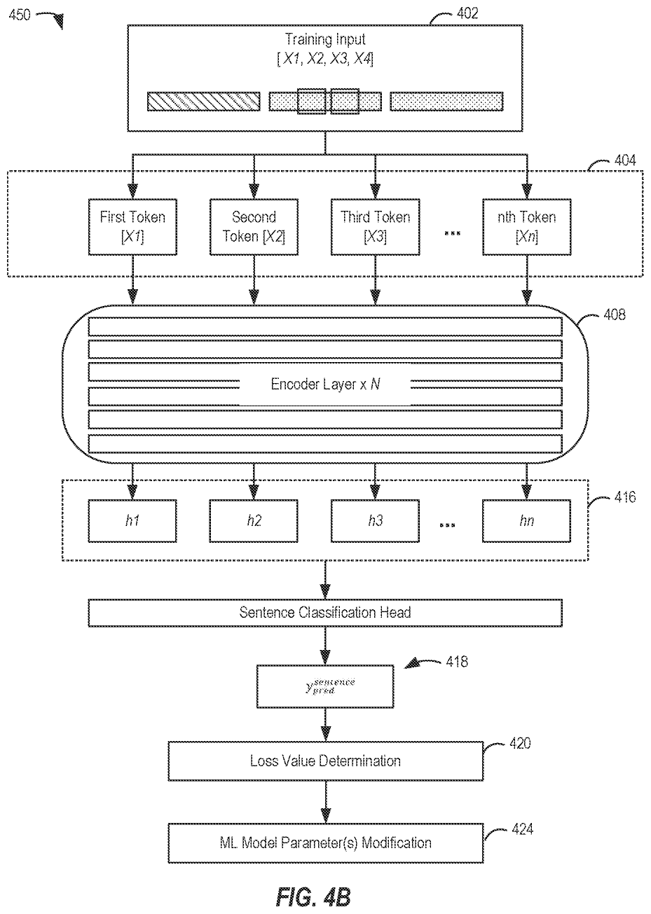

Additional details regarding token-level slang usage classification are provided herein with respect to FIG. 4A, and additional details regarding sentence-level slang usage classification are provided herein with respect to FIG. 4B.

Token generation for slang usage mitigation training 118 (simply referred to herein as “mitigation training 118”) includes training the slang usage mitigation ML model to generate an output sentence, not having any slang tokens, from an input sentence including one or more slang tokens. For example, mitigation training 118 may be used to express a slang sentence, including two or more tokens, in an alternative way, such that the generated output sentence has a similar meaning to the input sentence (e.g., the slang sentence) (e.g., an entailment score satisfies a threshold) but does not include any slang tokens. For example, each existing training data instance 104 comprising an example sentence of a slang token used to generate a training data instance 104 comprising an example sentence that does not include the slang token may be used as training input for the ML model. Further, the generated training data instances 104 comprising the example sentences, not including the slang tokens, may be used as training output. The ML model may be trained to predict the corresponding training output for each training input. The predicted output sentences, for each training input sentence may be compared to the corresponding training output of the training, and one or more parameter(s) of the ML model may be adjusted based on the comparison.

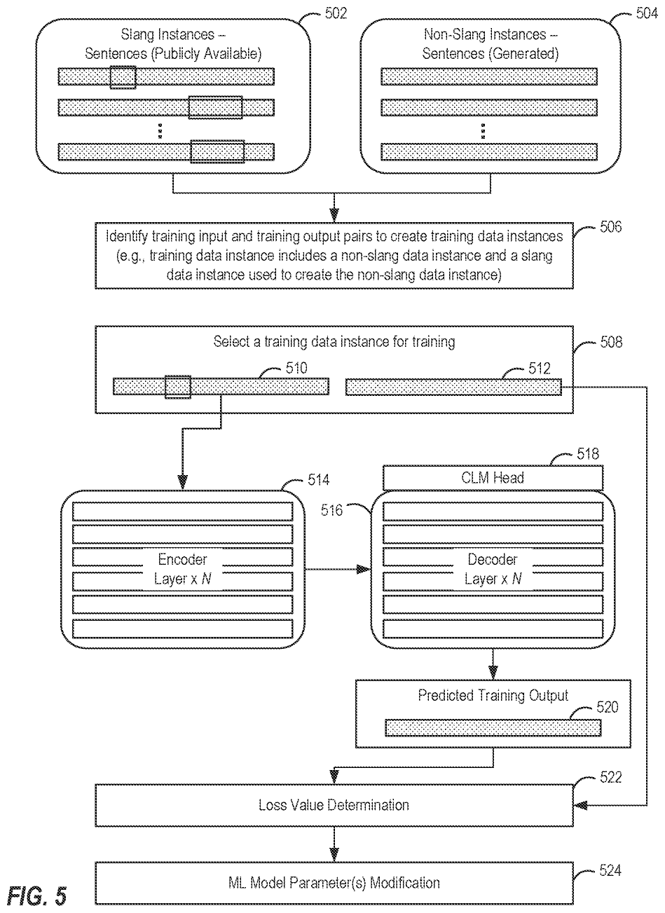

Additional details regarding token generation for slang usage mitigation training 118 are provided herein with respect to FIG. 5.

Slang usage classification 122 includes performing sentence-level slang usage classification or token-level slang usage classification. Sentence-level slang usage classification includes, using the trained slang usage detection ML model (e.g., trained at 114) to process input tokens (e.g., an input sentence) and classify the entire input as slang or not. Alternatively, token-level slang usage classification includes, using the trained ML model (e.g., trained at 116) to process input tokens (e.g., an input sentence) and classify each of the input tokens as slang or not.

For example, an input plurality of tokens may be “I have a cold, but my FOMO made me come to this party.” The trained slang usage detection ML model may be used, in some cases, to perform sentence-level slang usage classification and classify the plurality of tokens as including slang content (e.g., generate a slang sentence classification for the input tokens). In some other cases, the trained slang usage detection ML model may be used to perform token-level slang usage classification to classify twelve of the thirteen tokens in “I have a cold, but my FOMO made me come to this party” as each not containing slang content and one of the thirteen tokens (representing “FOMO”) as containing slang content (e.g., generate twelve non-slang token classifications and one slang token classification for the input plurality of tokens as a sequence of token classifications).

Instances determined by the trained slang usage detection ML model to not include slang may be used in downstream task(s) and/or downstream application(s). On the other hand, instances determined by the trained slang usage detection ML model to include slang may be modified to remove slang (while maintaining entailment) prior to being used in downstream task(s) and/or downstream application(s). For example, in certain embodiments, at token generation for slang usage mitigation 126, the input tokens are provided to the trained slang usage mitigation model (e.g., trained at 118) to generate a plurality of tokens not containing any slang tokens. An entailment score for the generated output tokens and the input tokens may satisfy a threshold thereby indicating that the generated output tokens are similar to the input plurality of tokens).

### Example Aspects Related to Dataset Generation and Labeling

As described with respect to FIG. 1, training a slang usage detection ML model and a slang usage mitigation ML model includes dataset generation and/or labeling (e.g., dataset generation 108 and/or dataset labeling 112 in FIG. 1). Dataset generation may include generating one or more training data instances (e.g., training data instances 104 in FIG. 1) from slang tokens, their corresponding definitions, and/or example sentences using the slang tokens. The training data instances may include slang data instance(s) and/or non-slang data instance(s). Dataset labeling may include assigning a single label to a plurality of tokens (e.g., a sentence-level label), as well as a single label to each individual token among the plurality of tokens. In some examples, the label assigned to the plurality of tokens may be (1) a slang instance label indicating the tokens include slang content or (2) a non-slang instance label indicating that the tokens do not include slang content. In some examples, the label assigned to each individual token may be (1) a slang token label indicating that the specific token contains slang content or (2) a non-slang token label indicating that the specific token does not include slang content.

Example dataset generation is illustrated in FIGS. 2A-2C. Specifically, FIG. 2A depicts an example publicly available slang dataset used to generate training data instances. FIG. 2B depicts example techniques for generating training data instances from the publicly available slang dataset. FIG. 2C depicts example techniques for determining an entailment score for each generated training data instance. Further, example dataset labeling is illustrated in FIG. 2D.

As shown in FIG. 2A, a public slang dataset 202 may include one or more slang tokens and one or more definitions for the slang tokens. Further, in some cases, a public slang dataset 202 may include one or more example sentences including the slang tokens (however, in some other cases, example sentences may not be available in a public slang dataset). For example, as shown, an example slang token included in public slang dataset 202 is “YOLO,” an example definition included in public slang dataset 202 is “To engage in impulsive or reckless behavior with the rationalization of once in a lifetime experience” for slang token “YOLO,” and an example sentence included in public slang dataset 202 is “I bought these expensive designer dressed I've been eyeing—YOLO!” for slang token “YOLO.” Each definition in public slang dataset 202 may be classified as a non-slang instance given that each definition does not include any slang content. Further, each example sentence included in public slang dataset 202 may be classified as a slang instance given that each sentence includes at least one slang token.

As shown in FIG. 2B, different options may be used to generate additional text for training ML models for slang detection and mitigation. In some embodiments, the generation may be performed by an LLM. In a first option, an LLM is prompted to process an example slang token and its corresponding definition (e.g., not including any slang tokens) to thereby generate an example sentence using the example slang token. For example, as shown in FIG. 2B, example slang token “YOLO” and its corresponding definition “To engage in impulsive or reckless behavior with the rationalization of once in a lifetime experience,” included in public slang dataset 202, may be processed by the LLM to generate an example sentence including the slang token “YOLO.” The LLM may be provided with example slang token “YOLO,” the corresponding definition, and prompt 206 stating “Here is a slang token with a definition, please write an example sentence(s) demonstrating realistic use of the slang token with the slang token in it.” Based on receiving prompt 206, the LLM may perform response generation 204 to generate response 208. Response 208 is an example sentence using “YOLO” that states, “I've been feeling so bored with my job lately, so I decided to quit and travel the world for a year. YOLO, right?”

In a second option, an LLM is prompted to process an example slang token, an example definition, and an example sentence including the slang token to thereby generate another example sentence that does not include the slang token. For example, as shown in FIG. 2B, example slang token “YOLO”, its corresponding definition “To engage in impulsive or reckless behavior with the rationalization of once in a lifetime experience,” and its corresponding example sentence “I bought these expensive designer dresses I've been eyeing-YOLO!,” included in public slang dataset 202, may be processed by the LLM to generate an example sentence without the slang token “YOLO.” The LLM may be provided with the example slang token, definition, and sentence from public slang dataset 202, as well as prompt 210 stating, “Here is a slang token with a definition and a corresponding example sentence, please write a paraphrase of the example sentence without the slang word.” Based on receiving prompt 210, the LLM may perform response generation 204 to generate response 212. Response 212 is an example sentence that does not use “YOLO,” but has a similar meaning to the example sentence from public slang dataset 202 that does use “YOLO.” In particular, response 212 is an example sentence that states, “I decided to purchase the expensive designer dresses I had been admiring, rationalizing that I should take advantage of the moment and live life to the fullest.”

The first option and/or the second option depicted in FIG. 2B may be used for one or more slang tokens, definitions, and/or example sentences included in public slang dataset 202 to generate additional data instances for training ML models. In certain embodiments, responses generated using the first option and/or the second option depicted in FIG. 2B may be checked to determine (1) whether the generated response includes the slang token or not (e.g., based on the prompt provided to the LLM and (2) whether the generated responses are similar to the input text used to generate the responses. For example, an entailment model may be used to determine an entailment score between input text (e.g., an example slang token and definition or an example slang token, definition, and sentence) and a generated response (e.g., including one or more slang tokens or not including any slang tokens).

For example, as shown in FIG. 2C, for the first option, at 220, response 208, generated from prompt 206, is checked to determine whether response 208 includes the slang token (e.g., provided as input in prompt 206). If response 208 does not include the slang token, then at 222, response 208 is discarded and not used for training the ML models. Alternatively, if response 208 does include the slang token, then at 224, an entailment model determines an entailment score for the response 208 based on the example definition included in prompt 206. At 226, it is determined whether the entailment score satisfies a threshold (e.g., entailment score is greater than a threshold thereby indicating sufficient entailment between response 208 and the example definition included in prompt 206). If the entailment score does not satisfy the threshold, then at 222, response 208 is discarded and not used for training the ML models. Alternatively, if the entailment score does satisfy the threshold, then at 228, response 208 is added to the training dataset and may be later used for training the ML models.

For the second option, as shown in FIG. 2C, at 240, response 212, generated from prompt 210, is checked to determine whether response 208 includes the slang token (e.g., provided as input in prompt 206). If response 208 does include the slang token, then at 242, response 212 is discarded and not used for training the ML models. Alternatively, if response 212 does not include the slang token, then at 244, an entailment model determines an entailment score for the response 212 based on the example definition (or alternatively, the example sentence, although not shown in FIG. 2C) included in prompt 206. At 246, it is determined whether the entailment score satisfies a threshold (e.g., entailment score is greater than a threshold thereby indicating sufficient entailment between response 208 and the example definition or the example sentence included in prompt 210). If the entailment score does not satisfy the threshold, then at 242, response 212 is discarded and not used for training the ML models. Alternatively, if the entailment score does satisfy the threshold, then at 248, response 212 is added to the training dataset and may be later used for training the ML models.

In certain embodiments, example definitions and/or sentences obtained from public slang dataset 202 and/or generated using techniques depicted in FIGS. 2A-2C are labeled prior to training the ML models for slang usage classification and/or mitigation. Example dataset labeling is depicted in FIG. 2D. Specifically, FIG. 2D depicts example dataset labeling for definitions included in public slang dataset 202, publicly-available sentences included in public slang dataset 202, and sentences generated from slang tokens, definitions, and/or example sentences included in public slang dataset 202.

Each definition from public slang dataset 202 may be a training data instance used to train the slang usage detection ML model. Each definition may be assigned a non-slang instance label, as well as non-slang token labels for each token included in each definition. Only non-slang instance labels and non-slang token labels may be assigned to the definitions as the text of these definitions do not include any slang content.

Each example sentence from public slang dataset 202 may be a training data instance used to train the slang usage detection ML model and/or the slang usage mitigation ML model. Each example sentence from public slang dataset 202 may be assigned a slang containing instance label. Further, each token in each example sentence may be assigned a slang token label or a non-slang token label. Only slang instance labels may be assigned to the example sentences as the text of these definitions each include slang content (e.g., are example uses of slang tokens).

Each example sentence generated using techniques provided in FIGS. 2A-2C may be a training data instance used to train the slang usage detection ML model and/or the slang usage mitigation ML model. Each generated sentence may be assigned a slang instance label or a non-slang instance label. Further, each token in each generated sentence may be assigned a slang token label or a non-slang token label.

As described in detail herein with respect to FIG. 5, in some cases, training data instances used to train the slang usage mitigation model include (1) a training input including an example sentence from public slang dataset 202 and (2) a training output including a generated sentence, not including any slang tokens, generated from the respective example sentence (e.g., using techniques described in FIGS. 2A-2C for the second option).

### Example Aspects Related to Masked Pre-Training

As described with respect to FIG. 1, training a slang usage detection ML model and a slang usage mitigation ML model may include MLM pre-training (e.g., MLM pre-training 110). MLM pre-training includes training each of the ML models to predict one or more masked tokens in a plurality of tokens provided as input to each ML model. The plurality of tokens provided as input to the ML models for pre-training, including one or more masked tokens, may include definitions (e.g., not including any slang tokens) obtained from a publicly available slang dataset (e.g., such as public slang dataset 202 described in FIG. 2A), example sentences including one or more slang tokens obtained from a publicly available slang dataset, and/or example sentences generated from a publicly available slang dataset that do not include any slang tokens (e.g., as described for the second option in FIGS. 2A-2C). The definitions and/or example sentences may be referred to herein as training data instances used to train the ML models for predicting masked token(s). MLM pre-training of the slang usage detection ML model and/or the slang usage mitigation ML model may be used to adapt each ML model to the slang domain, such that the models are better situated for understanding, detecting, and/or mitigating slang usage.

FIG. 3 depicts example MLM pre-training used to adapt an ML model (e.g., such as the slang usage detection ML model or the slang usage mitigation ML model) to the slang domain. As shown in FIG. 3, training data instances used to train the ML model may include non-slang instance(s) 302 including one or more definitions. The definition(s) may not include any slang tokens and may be obtained from a publicly available slang dataset. Training data instances used to train the ML model may also include slang instance(s) 304 including one or more sentences obtained from a publicly available slang dataset. The one or more sentences may be example sentences using one or more slang tokens. Further, training data instances used to train the ML model may include slang instance(s) 306 including one or more sentences generated from text in a publicly available slang dataset (e.g., generated according to techniques described in FIGS. 2A-2C).

To perform the MLM pre-training, at least one token included in each training data instance may be masked (e.g., concealed, covered, removed, etc.). In certain embodiments, masking includes randomly masking token(s) per training data instance. In certain embodiments, masking includes randomly masking at least a percentage (e.g., such as a percentage within a range of 10-20%) of the tokens for each training data instance. In certain embodiments, masking includes masking slang tokens included in slang instances 304 (e.g., referred to as “slang targeted masking”). Masked non-slang instances 308, masked slang instances 310, and masked slang instances 312 are used to train the ML model.

For example, a transformer encoder architecture 326 of the ML model, including a MLM head 324, may be trained to predict the masked token(s) for each instance provided as training input 322 to the ML model and thereby generate predicted training output 328 (e.g., comprising two or more tokens), including at least the predicted token(s) for the masked token(s) in training input 322.

Loss value determination 332 is then performed to determine whether to modify one or more parameters of the ML model. Loss value determination 332 may include evaluating the similarity of each predicted training output 328, generated for each training input 322, to an expected training output 330 associated with the respective training input 322 processed by the ML model to generate predicted training output 328. In particular, expected training output 330 may comprise the instance used to create training input 322 without the one or more masked tokens (e.g., an instance from non-slang instances 302, slang s 304, or non-slang instances 306). For example, training input 322 may state “I have major [MASK],” while expected training output 330 states “I have major FOMO.” Training output 330 stating, “I have major FOMO” may include the slang token “FOMO” that is masked in training input 322.

In certain embodiments, evaluating the similarity of each predicted training output 328, generated for each training input 322, to an expected training output 330 associated with the respective training input 322 is performed using a loss function. The loss function is a mathematical function that measures how well the ML model is able to predict the desired output, and more specifically, the expected training output 330 associated with the training input 322 used to generate the predicted training output 328). For example, assuming training input 322 states “I have major [MASK],” ML model generates predicted training output 328 stating “I have major FOMO,” and expected training output 330 states “I have major FOMO,” then the loss value determined for loss value determination 332 may be minimized (or equal to zero) given the predicted training output 328 matches the expected training output 330 exactly.

Determining whether to modify one or more parameters of the ML model, at 334, may be based on the loss value determined for loss value determination 332.

### Example Aspects Related to Training an ML Model for Slang Usage Detection

As described with respect to FIG. 1, training ML models for slang usage detection and mitigation may include training a slang usage detection ML model for sentence-level slang usage classification or token-level slang usage classification. For example, in certain embodiments, the slang usage detection ML model is trained to identify a plurality of tokens (e.g., a training data instance), provided as input to the ML model, as a slang or non-slang instance (e.g., a slang or non-slang sentence) (e.g., where the ML model includes a sentence classification head). In certain other embodiments, the slang usage detection ML model is used to identify each token, of a plurality of tokens (e.g., a training data instance) provided as input to the ML model, as a slang or non-slang token (e.g., where the ML model includes a token classification head). FIG. 4A depicts example training of the slang usage detection ML model for token-level slang usage classification. FIG. 4B depicts example training of the slang usage detection ML model for sentence-level slang usage classification.

As depicted in both FIGS. 4A and 4B, training input 402 is used as input to train the slang usage detection ML model. Training input 402 includes two or more tokens, e.g., [X1, X2, X3, . . . . Xn] (e.g., up to n tokens, where n is an integer greater than one).

Training input 402 may be a training data instance obtained from a publicly available dataset, such as public slang dataset 202 described with respect to FIG. 2A, or a training data instance generated using text from a publicly available dataset (e.g., generated according to the techniques described in FIGS. 2A-2C). More specifically, training input 402 may include (1) a definition for a slang token that is obtained from a publicly available dataset or generated, (2) a plurality of tokens including at least one slang token (e.g., an example sentence using a slang token) that is generated or obtained from a publicly available dataset, or (3) a plurality of tokens not including any slang tokens (e.g., an example sentence not using any slang token) that is generated from a plurality of tokens including a slang token. Training input 402 may have been previously assigned one of a slang instance label or a non-slang instance label. Further, each token in training input 402 may have been previously assigned one of a slang token label or a non-slang token label. Labeling of training input 402 may have been performed according to the techniques described above with respect to FIG. 2D.

Although not meant to be limiting, in this example, training input 402 may recite “I have major FOMO” and thus includes four tokens. As such, training input 402 may be assigned a slang instance label, as well as one slang token label for token “FOMO” and three non-slang token labels for tokens “I,” “have,” and “major.”

Training input 402 is tokenized, at 404, into each of its respective tokens and provided to an input layer of an ML model. The ML model includes one or more encoder layers 406 (e.g., N encoder layers 406, where N is an integer greater than zero) and one or more classification layers (e.g., not shown). The one or more encoder layers 406 of the ML model may process the tokens and thereby produce an embedding for each token. For example, a hidden representation vector may be generated for each token (e.g., h1 is produced for first token X1, h2 is produced for second token X2, etc.), which is shown at 408 in FIG. 4.

In FIG. 4A, a classification layer of the slang usage detection ML model (e.g., including the token classification head) may be used to perform token-level slang usage classification. For token-level slang usage classification, the ML model may generate a token-level slang usage classification for each of the tokens included in training input 402. In particular, the ML model may generate classification y_{pred}^{token}1 for token X1, classification y_{pred}^{token}2 for token X2, classification y_{pred}^{token}3 for token X3, etc. (e.g., shown at 410). In certain embodiments, the ML model generates the token-level slang usage classifications for training input 402 as a single sequence of outputs. The ML model may generate a token-level slang usage classification for a particular token based on the hidden representation vector generated for the particular token (e.g., h1 is used to generate y_{pred}^{token}1 for token X1). The token-level slang usage classification generated for each token may classify the respective token as a slang token or a non-slang token.

Loss value determination 412 is then performed to determine whether to modify one or more parameters of the ML model. Loss value determination 412 may include evaluating the similarity of the classification, y_{pred}^{token}, generated for each token of training input 402, to the token-level label assigned to the respective token. In certain embodiments, evaluating the similarity of the classification, y_{pred}^{token}, to each token-level label is performed using a loss function.

For example, assuming training input 402 recites “I have major FOMO,” the ML model may generate four token-level slang usage classifications. If, for tokens “I,” “have,” and “major,” the ML model predicts that these tokens are non-slang tokens and token “FOMO” is a slang token, then the loss function may be minimized (or zero, thereby indicating an exact match). However, if one of the tokens is given an opposite classification, the loss value determined at loss value determination 412 may increase.

Determining whether to modify one or more parameters of the ML model, at 414, may be based on the loss value determined for loss value determination 412 in FIG. 4A.

In FIG. 4B, a classification layer of the ML model (e.g., including the sentence classification head) may be used to perform sentence-level slang usage classification for training input 402. More specifically, the ML model may collectively use the hidden representation vector generated for each token of training input 402 (e.g., aggregation 416 of h1, h2, h3 . . . hn) to generate the sentence-level slang usage classification, y_{pred}^{sentence} (e.g., shown at 418). The sentence-level slang usage classification may classify training input 402 as a slang instance or a non-slang instance.

Loss value determination 420 is then performed to determine whether to modify one or more parameters of the ML model. Loss value determination 420 may include evaluating the similarity of the classification, y_{pred}^{sentence}, to the sentence-level label assigned to training input 402. In certain embodiments, evaluating the similarity of the classification, y_{pred}^{sentence}, to the sentence-level label is performed using a loss function.

The loss value determined for loss value determination 420 in FIG. 4B may also be increased in cases where the sentence-level classification, generated for training input 402, does not match the sentence-level label assigned to training input 402 (e.g., indicating an incorrect prediction by the ML model). Alternatively, the loss value determined for loss value determination 414 may be decreased in cases where the second output, e.g., the sentence-level classification, generated for training input 402 does match the sentence-level label assigned to training input 402 (e.g., indicating a correct prediction by the ML model).

Determining whether to modify one or more parameters of the ML model, at 424, may be based on the loss value determined for loss value determination 420 in FIG. 4B.

In certain embodiments, multiple training inputs 402 are used to train the ML model. For example, multiple training inputs 402 may be provided as input into the ML model to (1) generate token-level slang usage classifications (e.g., per token for each training input 402) or sentence-level slang usage classifications (e.g., per training input 402), (2) determine loss values, and, in some cases, (3) modify parameter(s) of the ML model. Training the ML model may be complete when all available training input (e.g., training data instances) has been used to train the ML model and/or when a desired stopping criteria for the training of the ML model is achieved.

### Example Aspects Related to Training an ML Model for Slang Usage Mitigation

As described with respect to FIG. 1, training ML models for slang usage detection and mitigation may include training a slang usage mitigation ML model to generate an output sentence, not including any slang tokens, from an input sentence including one or more slang tokens. For example, in certain embodiments, the slang usage mitigation ML model is trained to rephrase slang-containing text and generate non-slang-containing text (e.g., slang free text), while maintaining a similar meaning as the slang-containing text. FIG. 5 depicts example training of the slang usage mitigation ML model for such slang usage mitigation.

As shown in FIG. 5, training data instances used to train the ML model may each include a training input 502 and a training output 504. The training input 502 for each training data instance may include a plurality of tokens including at least one slang token. For example, each training input 502 may be an example sentence from a publicly available dataset (e.g., such as public slang dataset 202 in FIG. 2A) comprising at least one slang token. Training output 504 corresponding to each training input 502 may include a plurality of tokens previously generated using the respective training input 502 according to the techniques for the second dataset generation option described with respect to FIGS. 2A-2C. For example, a training output 504 may be sentence generated, without any slang tokens, from a training input 502 including an example sentence having at least one slang token. An entailment score above a threshold may exist for each pair of training input 502 and training output 504. Identifying training input 502 and training output 504 pairs to create a plurality of training data instances used to train the ML model occurs at 506 in FIG. 5.

At 508, a training data instance is selected for training the ML model. The selected training data instance may include a training input 510 and a training output 512. By way of example, the training data instance may include a training input 510 stating, “I bought these expensive designer dresses I've been eyeing-YOLO!” (e.g., including slang token “YOLO”) and a training output 512 stating, “I decided to purchase the expensive designer dresses I had been admiring, rationalizing that I should take advantage of the moment and live life to the fullest” (e.g., not including any slang tokens).

At 514, training input 510, e.g., an example input sentence, is provided to an input layer of a slang usage mitigation ML model. The ML model includes one or more encoder layers and one or more decoder layers (e.g., N encoder/decoder layers, where N is an integer greater than zero), as well as a causal language modeling (CLM) head 518. A CLM head (e.g., where CLM is an autoregressive method) may be added to an ML model to fine tune the model, and more specifically, train the ML model to predict a next token in a sequence given the previous tokens (e.g., only consider the past (e.g., preceding token(s)) and not the future (e.g., subsequent token(s)) context when generating predictions). The one or more encoder layers of the ML model may have been pre-trained for the slang domain according to the techniques described herein with respect to FIG. 3. The encoder layer(s) may process tokens of training input 510 and thereby produce an encoder-representation embedding for each token. The encoder-representation embedding produced for each token may be a representation of the token based on its context (e.g., the parts/tokens that precede or follow the specific token in the input sentence).

At 516, the encoder-representation embedding is provided as input to the one or more decoder layers of the ML model. The decoder layers are trained to generate a plurality of tokens, e.g., an example output sentence, for training input 510 that does not include any slang tokens. The decoder may use the embedding to generate the output sentence for training input 510. The generated output sentence is illustrated as predicted training output 520 in FIG. 5.

At 522, loss value determination is performed to determine whether to modify one or more parameters of the ML model. Loss value determination, at 522, may include evaluating the similarity of the generated output sentence to training output 512 (e.g., a sentence that does not include any slang tokens). In certain embodiments, evaluating the similarity of the generated plurality of tokens to training output 512 is performed using a loss function. Determining whether to modify one or more parameters of the ML model, at 524, may be based on the loss value determined at 522.

In certain embodiments, multiple training inputs 510 are selected (e.g., from training inputs 502) and used to train the slang usage mitigation ML model. For example, multiple training inputs 510 may be provided as input into the ML model to (1) generate output sentences that do not include any slang tokens, (2) determine loss values, and, in some cases, (3) modify parameter(s) of the ML model. Training the ML model may be complete when all available training input 502 (e.g., training data instances) have been used to train the ML model and/or when desired training stopping criteria is achieved. One example of training stopping criteria includes convergence (e.g., further training may not lead to any significant loss reduction). Another example of training stopping criteria includes a number of training steps/epoches reaching pre-determined limit(s) (e.g., a maximum number) and/or divergence (e.g., further training may cause over-fitting as diagnosable by increasing evaluation loss). Another example of training stopping criteria includes a number of contiguous training epochs during which training loss is not decreasing more than a threshold amount (e.g., patience).

### Example System for Content Moderation

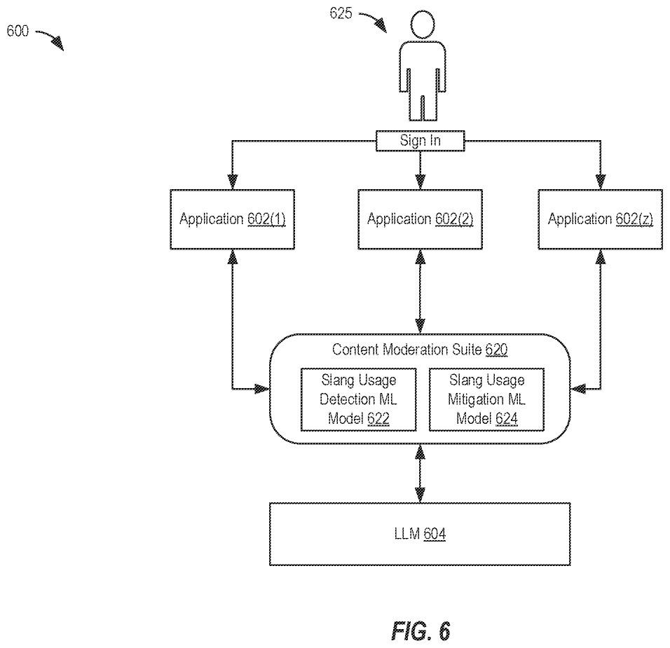

FIG. 6 depicts an example system 600 where content moderation techniques, such as slang usage detection and mitigation techniques described above, may be used. For example, as shown, a content moderation suite 620 may be implemented in system 600. The content moderation suite 620 may include a trained slang usage detection ML model 622 and/or a slang usage mitigation ML model 624 for performing slang usage detection and mitigation, respectively.

As such, when a user 625 signs in and interacts with an application 602(1), 602(2), etc. that relies on an LLM 604 for content generation, user-provided input (e.g., from user 625) and/or LLM-generated output (e.g., from LLM 604) may be processed through content moderation suite 620. For example, user-provided input and/or LLM-generated output may be processed by slang usage detection ML model 622 to detect whether the input or output text includes one or more slang tokens, and, further, in some cases, processed by slang usage mitigation ML model 624 to mitigate slang content, where it is present.

Slang usage mitigation ML model 624 may mitigate slang content by, for example, generating an output sentence, also referred to herein as a “sanitized sentence”, not including any slang tokens, from an input sentence (e.g., provided by user 625 and/or generated by LLM 604) including one or more slang tokens. In some cases, the sanitized sentence is then used to prompt LLM 604, instead of prompting LLM 604 with the user-provided input sentence including one or more slang tokens. Use of sanitized sentences when prompting LLM 604 (1) helps to ensure that various users of application(s) 602 have the same generative AI-based experience when interacting with/using application(s) 602 that rely on LLM 604 and (2) helps to avoid the generation of slang content by LLM 604. In some cases, where the sanitized sentence is generated as an alternative to an LLM 604 output sentence including slang tokens, the sanitized sentence may be returned to application(s) 602, instead of the original slang output sentence generated by LLM 604. This helps to avoid the dissemination of slang-containing text to users (e.g., such as user 625) and/or application(s) 602 that rely on LLM 604 for content generation.

### Example Method for Training an ML Model to Detect Profanity

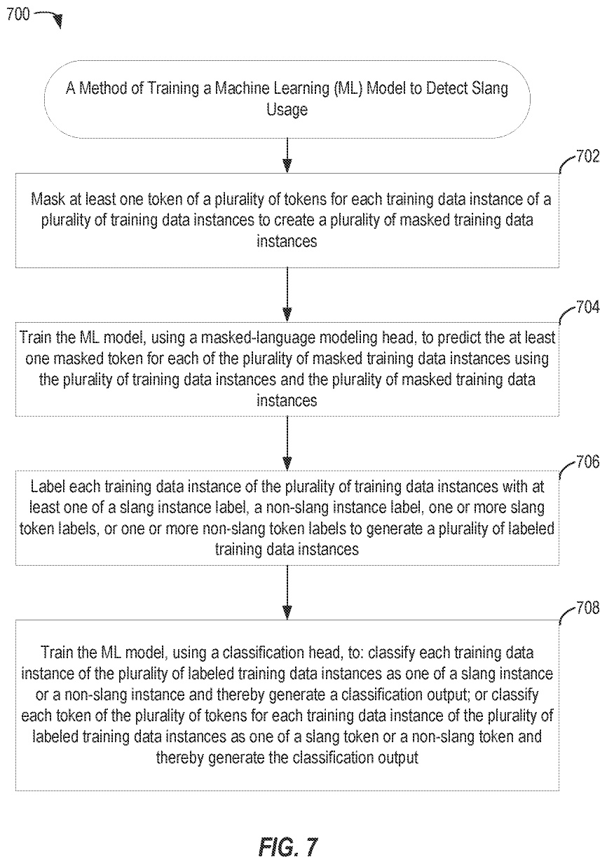

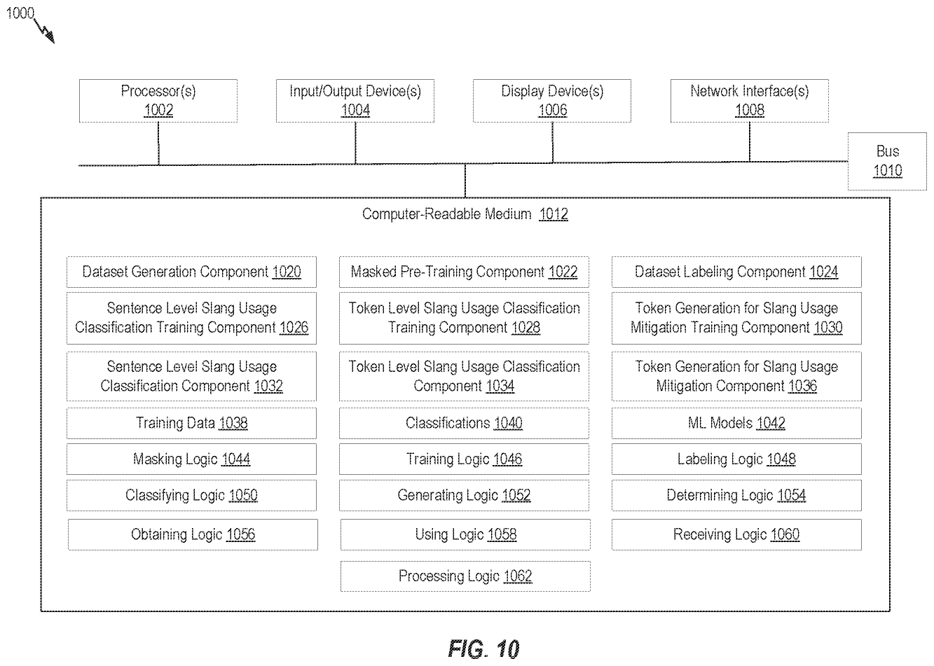

FIG. 7 depicts an example method 700 for training an ML model to detect slang usage. Method 700 may be performed by one or more processor(s) of a computing device, such as processor(s) 1002 of processing system 1000 described below with respect FIG. 10.

Method 700 begins, at step 702, with masking at least one token of a plurality of tokens for each training data instance of a plurality of training data instances to create a plurality of masked training data instances. The plurality of tokens for each training data instance in a first subset of the plurality of training data instances may not include at least one slang token of a plurality of slang tokens. The plurality of tokens for each training data instance in a second subset of the plurality of training data instances may include the at least one slang token of the plurality of slang tokens.

Method 700 proceeds, at step 704, with training the ML model, using a masked-language modeling head, to predict the at least one masked token for each of the plurality of masked training data instances using the plurality of training data instances and the plurality of masked training data instances.

Method 700 proceeds, at step 706, with labeling each training data instance of the plurality of training data instances with at least one of a slang instance label, a non-slang instance label, one or more slang token labels, or one or more non-slang token labels to generate a plurality of labeled training data instances.

Method 700 proceeds, at step 708, with training the ML model, using a classification head, to: classify each training data instance of the plurality of labeled training data instances as one of a slang instance or a non-slang instance and thereby generate a classification output; or classify each token of the plurality of tokens for each training data instance of the plurality of labeled training data instances as one of a slang token or a non-slang token and thereby generate the classification output. In some cases, step 708 includes training the ML model to classify each training data instance as a slang instance or a non-slang instance and classify each token of each training data instance as slang and/or non-slang token(s), such that both sentence-level and token-level classification outputs are generated by the ML model.

In certain embodiments, each training data instance in the first subset of the plurality of training data instances comprises at least a definition associated with a slang token in the plurality of slang tokens. In certain embodiments, method 700 further includes generating the second subset of the plurality of training data instances by, for each training data instance in the first subset of the plurality of training data instances: (1) generating, by a large language model (LLM), a plurality of output tokens based on a prompt comprising the respective training data instance and the slang token associated with the respective training data instance; (2) determining the plurality of output tokens comprise the slang token; and (3) determining, by an entailment model, that an entailment score between the definition of the respective training data instance and the plurality of output tokens satisfies a threshold.

In certain embodiments, each training data instance in the second subset of the plurality of training data instances includes at least a definition of a slang token in the plurality of slang tokens and a first sentence comprising the slang token. In certain embodiments, method 700 further includes generating the first subset of the plurality of training data instances by, for each training data instance in the second subset of the plurality of training data instances: (1) generating, by a large language model (LLM), a plurality of output tokens based on a prompt comprising the first sentence of the respective training data instance comprising the slang token; (2) determining the plurality of output tokens do not comprise the slang token; and (3) determining, by an entailment model, that an entailment score between the definition of the respective training data instance and the plurality of output tokens or between the first sentence and the plurality of output tokens satisfies a threshold.

In certain embodiments, masking the at least one token of the plurality of tokens for each training data instance of the plurality of training data instances to create the plurality of masked training data instances comprises randomly masking at least a first percentage of the plurality of tokens for each training data instance.

In certain embodiments, masking the at least one token of the plurality of tokens for each training data instance of the plurality of training data instances to create the plurality of masked training data instances comprises masking the at least one slang token included in the plurality of tokens for each training data instance in the second subset of the plurality of training data instances.

In certain embodiments, the ML model comprises an encoder only transformer architecture. In certain embodiments, the encoder only transformer architecture comprises a decoding-enhanced bidirectional encoder representations from transformers with disentangled attention (DeBERTa) model.

Note that FIG. 7 is just one example of a method, and other methods including fewer, additional, or alternative steps are possible consistent with this disclosure.

### Example Method for Training an ML Model to Mitigate Slang Usage

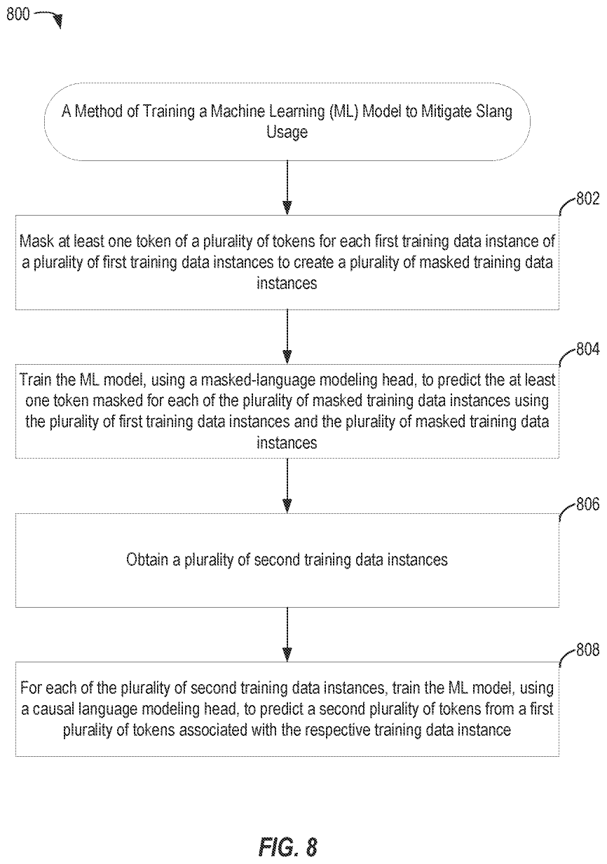

FIG. 8 depicts an example method 800 for training an ML model to mitigate slang usage. Method 800 may be performed by one or more processor(s) of a computing device, such as processor(s) 1002 of processing system 1000 described below with respect FIG. 10.

Method 800 begins, at step 802, with masking at least one token of a plurality of tokens for each first training data instance of a plurality of first training data instances to create a plurality of masked training data instances. The plurality of tokens for each first training data instance in a first subset of the plurality of first training data instances may not include at least one slang token of a plurality of slang tokens. The plurality of tokens for each first training data instance in a second subset of the plurality of first training data instances may include the at least one slang token of the plurality of slang tokens.

Method 800 proceeds, at step 804, with training the ML model, using a masked-language modeling head, to predict the at least one token masked for each of the plurality of masked training data instances using the plurality of first training data instances and the plurality of masked training data instances.

Method 800 proceeds, at step 806, with obtaining a plurality of second training data instances. Each second training data instance may include a training input comprising a first plurality of tokens including the at least one slang token of the plurality of slang tokens and a training output comprising a second plurality of tokens that do not include the at least one slang token of the plurality of slang tokens, wherein an entailment score between the training input and the training output of the respective second training data instance is greater than a threshold.

Method 800 proceeds, at step 808, with, for each of the plurality of second training data instances, training the ML model, using a causal language modeling head, to predict the second plurality of tokens from the first plurality of tokens.

In certain embodiments, each training data instance in the first subset of the plurality of first training data instances includes at least a definition associated with a slang token in the plurality of slang tokens. In certain embodiments, method 800 further includes generating the second subset of the plurality of first training data instances by, for each training data instance in the first subset of the plurality of first training data instances: (1) generating, by a large language model (LLM), a plurality of output tokens based on a prompt comprising the respective training data instance and the slang token associated with the respective training data instance; (2) determining the plurality of output tokens comprise the slang token; and (3) determining, by an entailment model, that an entailment score between the definition of the respective training data instance and the plurality of output tokens satisfies a threshold.

In certain embodiments, each training data instance in the second subset of the plurality of first training data instances includes at least a definition of a slang token in the plurality of slang tokens and a first sentence comprising the slang token. In certain embodiments, method 800 further includes generating the first subset of the plurality of first training data instances by, for each training data instance in the second subset of the plurality of first training data instances: (1) generating, by a LLM, a plurality of output tokens based on a prompt comprising the first sentence of the respective training data instance comprising the slang token; (2) determining the plurality of output tokens do not comprise the slang token; and (3) determining, by an entailment model, that an entailment score between the definition of the respective training data instance and the plurality of output tokens satisfies a threshold.

In certain embodiments, masking the at least one token of the plurality of tokens for each training data instance of the plurality of first training data instances to create the plurality of masked training data instances includes randomly masking at least a first percentage of the plurality of tokens for each first training data instance.

In certain embodiments, masking the at least one token of the plurality of tokens for each first training data instance of the plurality of first training data instances to create the plurality of masked training data instances includes masking the at least one slang token included in the plurality of tokens for each first training data instance in the second subset of the plurality of first training data instances.

In certain embodiments, the ML model includes an encoder-decoder transformer architecture.

Note that FIG. 8 is just one example of a method, and other methods including fewer, additional, or alternative steps are possible consistent with this disclosure.

### Example Method for Slang Usage Detection and Mitigation

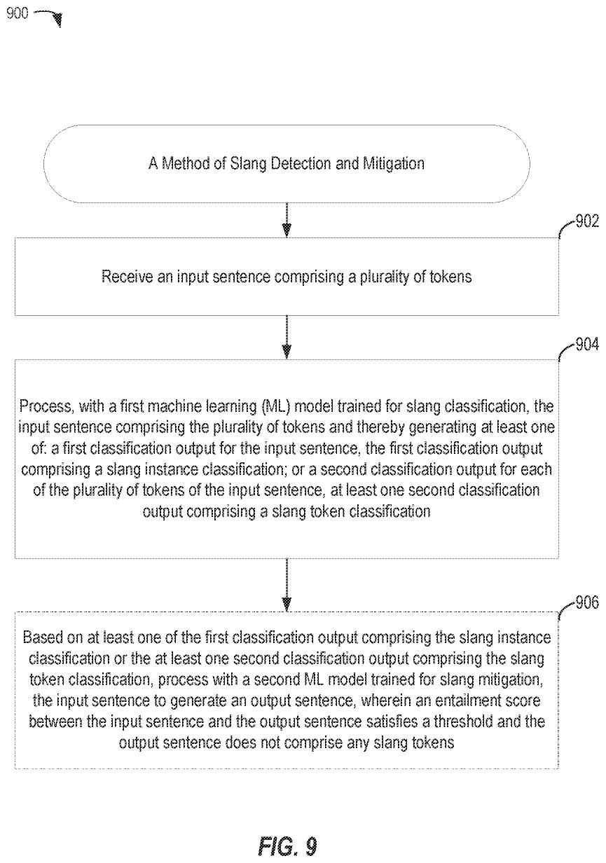

FIG. 9 depicts an example method 900 for slang usage detection and mitigation. Method 900 may be performed by one or more processor(s) of a computing device, such as processor(s) 1002 of processing system 1000 described below with respect FIG. 10.

Method 900 begins, at step 902, with receiving an input sentence comprising a plurality of tokens.

Method 900 proceeds, at step 904, with processing, with a first machine learning (ML) model trained for slang classification, the input sentence comprising the plurality of tokens and thereby generating at least one of: a first classification output for the input sentence, the first classification output comprising a slang instance classification; or a second classification output for each of the plurality of tokens of the input sentence, at least one second classification output comprising a slang token classification.

In certain embodiments, method 900 optionally proceeds, at step 906, with based on at least one of the first classification output comprising the slang instance classification or the at least one second classification output comprising the slang token classification, processing with a second ML model trained for slang mitigation, the input sentence to generate an output sentence, wherein (1) an entailment score between the input sentence and the output sentence satisfies a threshold and (2) the output sentence does not comprise any slang tokens.

In certain embodiments, method 900 further includes using the output plurality of tokens to perform one or more tasks.

In certain embodiments, the first ML model comprises an encoder only transformer architecture; and the second ML model comprises an encoder-decoder transformer architecture.

In certain embodiments, method 900 further includes prior to using the first ML model to process the input sentence to generate at least one of the first classification output or the second classification output: training the first ML model, using a masked-language modeling head, to predict at least one token masked for each of a plurality of masked training data instances and training the first ML model, using a classification head and a plurality of non-masked training data instance, to generate an instance-level slang classification or a token-level slang classification. Each training data instance of a first subset of the plurality of masked training data instances may not include at least one slang token of a plurality of slang tokens. Each training data instance of a second subset of the plurality of masked training data instances may include the at least one slang token of the plurality of slang tokens.

In certain embodiments, method 900 further includes, prior to using the second ML model to process the input sentence to generate the output sentence: training the second ML model, using a masked-language modeling head, to predict at least one token masked for each of a plurality of masked training data instances, wherein: each training data instance of a first subset of the plurality of masked training data instances does not include at least one slang token of a plurality of slang tokens, and each training data instance of a second subset of the plurality of masked training data instances comprises the at least one slang token of the plurality of slang tokens.

In certain embodiments, method 900 further includes, training the second ML model, using a causal language modeling head, to generate a second output sentence from a second input sentence including the at least one slang token of the plurality of slang tokens.

Note that FIG. 9 is just one example of a method, and other methods including fewer, additional, or alternative steps are possible consistent with this disclosure.

### Example Processing System for Slang Usage Detection and Mitigation

FIG. 10 depicts an example processing system 1000 configured to perform various aspects described herein, including, for example, method 700 as described above with respect to FIG. 7, method 800 as described above with respect to FIG. 8, and/or method 900 as described above with respect to FIG. 9.

Processing system 1000 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1000 includes one or more processors 1002, one or more input/output devices 1004, one or more display devices 1006, one or more network interfaces 1008 through which processing system 1000 is connected to one or more networks (e.g., a local network, an intranet, the Internet, or any other group of processing systems communicatively connected to each other), and computer-readable medium 1012. In the depicted example, the aforementioned components are coupled by a bus 1010, which may generally be configured for data exchange amongst the components. Bus 1010 may be representative of multiple buses, while only one is depicted for simplicity.

Processor(s) 1002 are generally configured to retrieve and execute instructions stored in one or more memories, including local memories like computer-readable medium 1012, as well as remote memories and data stores. Similarly, processor(s) 1002 are configured to store application data residing in local memories like the computer-readable medium 1012, as well as remote memories and data stores. More generally, bus 1010 is configured to transmit programming instructions and application data among the processor(s) 1002, display device(s) 1006, network interface(s) 1008, and/or computer-readable medium 1012. In certain embodiments, processor(s) 1002 are representative of one or more central processing units (CPUs), graphics processing unit (GPUs), tensor processing unit (TPUs), accelerators, and other processing devices.

Input/output device(s) 1004 may include any device, mechanism, system, interactive display, and/or various other hardware and software components for communicating information between processing system 1000 and a user of processing system 1000. For example, input/output device(s) 1004 may include input hardware, such as a keyboard, touch screen, button, microphone, speaker, and/or other device for receiving inputs from the user and sending outputs to the user.

Display device(s) 1006 may generally include any sort of device configured to display data, information, graphics, user interface elements, and the like to a user. For example, display device(s) 1006 may include internal and external displays such as an internal display of a tablet computer or an external display for a server computer or a projector. Display device(s) 1006 may further include displays for devices, such as augmented, virtual, and/or extended reality devices. In various embodiments, display device(s) 1016 may be configured to display a graphical user interface.

Network interface(s) 1008 provide processing system 1000 with access to external networks and thereby to external processing systems. Network interface(s) 1008 can generally be any hardware and/or software capable of transmitting and/or receiving data via a wired or wireless network connection. Accordingly, network interface(s) 1008 can include a communication transceiver for sending and/or receiving any wired and/or wireless communication.

Computer-readable medium 1012 may be a volatile memory, such as a random access memory (RAM), or a nonvolatile memory, such as nonvolatile random access memory (NVRAM), or the like. In this example, computer-readable medium 1012 includes dataset generation component 1020, MLM pre-training component 1022, dataset labeling component 1024, sentence level-slang usage classification training component 1026, token-level slang usage classification training component 1028, token generation for slang usage mitigation training component 1030, sentence-level slang usage classification component 1032, token-level slang usage classification component 1034, token generation for slang usage mitigation component 1036, training data 1038, classification 1040, ML models 1042, masking logic 1044, training logic 1046, labeling logic 1048, classifying logic 1050, generating logic 1052, determining logic 1054, obtaining logic 1056, using logic 1058, receiving logic 1060, and processing logic 1062.

In certain embodiments, masking logic 1044 includes logic for masking at least one token of a plurality of tokens for each training data instance of a plurality of training data instances to create a plurality of masked training data instances. In certain embodiments, masking logic 1044 includes logic for randomly masking at least a first percentage of the plurality of tokens for each training data instance. In certain embodiments, masking logic 1044 includes logic for masking the at least one slang token included in the plurality of tokens for each training data instance in the second subset of the plurality of training data instances.

In certain embodiments, training logic 1046 includes logic for training the ML model, using a masked-language modeling head, to predict the at least one masked token for each of the plurality of masked training data instances using the plurality of training data instances and the plurality of masked training data instances. In certain embodiments, training logic 1046 includes logic for training the ML model classify each training data instance of the plurality of labeled training data instances as one of a slang instance or a non-slang instance and thereby generate a classification output or classify each token of the plurality of tokens for each training data instance of the plurality of labeled training data instances as one of a slang token or a non-slang token and thereby generate the classification output. In certain embodiments, training logic 1046 includes logic for training the ML model, using a causal language modeling head, to predict the second plurality of tokens from the first plurality of tokens.

In certain embodiments, labeling logic 1048 includes logic for labeling each training data instance of the plurality of training data instances with at least one of a slang instance label, a non-slang instance label, one or more slang token labels, or one or more non-slang token labels to generate a plurality of labeled training data instances.

In certain embodiments, classifying logic 1050 includes logic for classifying a plurality of tokens as a slang instance or a non-slang instance. In certain embodiments, classifying logic 1050 includes logic for classifying each token of a plurality of tokens as a slang token or a non-slang token.

In certain embodiments, generating logic 1052 includes logic for generating, by a LLM, a plurality of output tokens based on a prompt comprising the respective training data instance and the slang token associated with the respective training data instance. In certain embodiments, generating logic 1052 includes logic for generating, by a LLM, a plurality of output tokens based on a prompt comprising the first sentence of the respective training data instance comprising the slang token.

In certain embodiments, determining logic 1054 includes logic for determining the plurality of output tokens comprise the slang token. In certain embodiments, determining logic 1054 includes logic for determining, by an entailment model, that an entailment score between the definition of the respective training data instance and the plurality of output tokens satisfies a threshold. In certain embodiments, determining logic 1054 includes logic for determining the plurality of output tokens do not comprise the slang token. In certain embodiments, determining logic 1054 includes logic for determining, by an entailment model, that an entailment score between the definition of the respective training data instance and the plurality of output tokens or between the first sentence and the plurality of output tokens satisfies a threshold.

In certain embodiments, obtaining logic 1056 includes logic for obtaining a plurality of second training data instances, wherein each second training data instance comprises: a training input comprising a first plurality of tokens including the at least one slang token of the plurality of slang tokens; and a training output comprising a second plurality of tokens that do not include the at least one slang token of the plurality of slang tokens, wherein an entailment score between the training input and the training output of the respective second training data instance is greater than a threshold.

In certain embodiments, using logic 1058 includes logic for using the output sentence to perform one or more tasks,

In certain embodiments, receiving logic 1060 includes logic for receiving an input sentence comprising a plurality of tokens.

In certain embodiments, processing logic 1062 includes logic for processing, with a first machine learning (ML) model trained for slang classification, the input sentence comprising the plurality of tokens and thereby generating a classification output. In certain embodiments, processing logic 1062 includes logic for processing with a second ML model trained for slang mitigation, the input sentence to generate an output sentence, wherein an entailment score between the input sentence and the output sentence satisfies a threshold.

Note that FIG. 10 is just one example of a processing system consistent with aspects described herein, and other processing systems having additional, alternative, or fewer components are possible consistent with this disclosure.

### Example Clauses

Implementation examples are described in the following numbered clauses:

Clause 1: A method of training a machine learning (ML) model to detect slang usage, comprising: masking at least one token of a plurality of tokens for each training data instance of a plurality of training data instances to create a plurality of masked training data instances, wherein: the plurality of tokens for each training data instance in a first subset of the plurality of training data instances does not include at least one slang token of a plurality of slang tokens, and the plurality of tokens for each training data instance in a second subset of the plurality of training data instances includes the at least one slang token of the plurality of slang tokens; training the ML model, using a masked-language modeling head, to predict the at least one masked token for each of the plurality of masked training data instances using the plurality of training data instances and the plurality of masked training data instances; labeling each training data instance of the plurality of training data instances with at least one of a slang instance label, a non-slang instance label, one or more slang token labels, or one or more non-slang token labels to generate a plurality of labeled training data instances; and training the ML model, using a classification head, to: classify each training data instance of the plurality of labeled training data instances as a slang instance or a non-slang instance and thereby generate a classification output; or classify each token of the plurality of tokens for each training data instance of the plurality of labeled training data instances as a slang token or a non-slang token and thereby generate the classification output.

Clause 2: The method of Clause 1, wherein: each training data instance in the first subset of the plurality of training data instances comprises at least a definition associated with a slang token in the plurality of slang tokens, and the method further comprises generating the second subset of the plurality of training data instances by, for each training data instance in the first subset of the plurality of training data instances: generating, by a large language model (LLM), a plurality of output tokens based on a prompt comprising the respective training data instance and the slang token associated with the respective training data instance; determining the plurality of output tokens comprise the slang token; and determining, by an entailment model, that an entailment score between the definition of the respective training data instance and the plurality of output tokens satisfies a threshold.

Clause 3: The method of any one of Clauses 1-2, wherein: each training data instance in the second subset of the plurality of training data instances comprises at least a definition of a slang token in the plurality of slang tokens and a first sentence comprising the slang token, and the method further comprises, generating the first subset of the plurality of training data instances by, for each training data instance in the second subset of the plurality of training data instances: generating, by a large language model (LLM), a plurality of output tokens based on a prompt comprising the first sentence of the respective training data instance comprising the slang token; determining the plurality of output tokens do not comprise the slang token; and determining, by an entailment model, that an entailment score between the definition of the respective training data instance and the plurality of output tokens or between the first sentence and the plurality of output tokens satisfies a threshold.

Clause 4: The method of any one of Clauses 1-3, wherein masking the at least one token of the plurality of tokens for each training data instance of the plurality of training data instances to create the plurality of masked training data instances comprises randomly masking at least a first percentage of the plurality of tokens for each training data instance.

Clause 5: The method of any one of Clauses 1-4, wherein masking the at least one token of the plurality of tokens for each training data instance of the plurality of training data instances to create the plurality of masked training data instances comprises masking the at least one slang token included in the plurality of tokens for each training data instance in the second subset of the plurality of training data instances.

Clause 6: The method of any one of Clauses 1-5, wherein the ML model comprises an encoder only transformer architecture.

Clause 7: The method of Clause 6, wherein the encoder only transformer architecture comprises a decoding-enhanced bidirectional encoder representations from transformers with disentangled attention (DeBERTa) model.

Clause 8: A method of training a machine learning (ML) model to mitigate slang usage, comprising: masking at least one token of a plurality of tokens for each first training data instance of a plurality of first training data instances to create a plurality of masked training data instances, wherein: the plurality of tokens for each first training data instance in a first subset of the plurality of first training data instances does not include at least one slang token of a plurality of slang tokens, and the plurality of tokens for each first training data instance in a second subset of the plurality of first training data instances includes the at least one slang token of the plurality of slang tokens; training the ML model, using a masked-language modeling head, to predict the at least one token masked for each of the plurality of masked training data instances using the plurality of first training data instances and the plurality of masked training data instances; obtaining a plurality of second training data instances, wherein each second training data instance comprises: a training input comprising a first plurality of tokens including the at least one slang token of the plurality of slang tokens; and a training output comprising a second plurality of tokens that do not include the at least one slang token of the plurality of slang tokens, wherein an entailment score between the training input and the training output of the respective second training data instance is greater than a threshold; and for each of the plurality of second training data instances, training the ML model, using a causal language modeling head, to predict the second plurality of tokens from the first plurality of tokens.

Clause 9: The method of Clause 8, wherein: each training data instance in the first subset of the plurality of first training data instances comprises at least a definition associated with a slang token in the plurality of slang tokens, and the method further comprises, generating the second subset of the plurality of first training data instances by, for each training data instance in the first subset of the plurality of first training data instances: generating, by a large language model (LLM), a plurality of output tokens based on a prompt comprising the respective training data instance and the slang token associated with the respective training data instance; determining the plurality of output tokens comprise the slang token; and determining, by an entailment model, that an entailment score between the definition of the respective training data instance and the plurality of output tokens satisfies a threshold.

Clause 10: The method of any one of Clauses 8-9, wherein: each training data instance in the second subset of the plurality of first training data instances comprises at least a definition of a slang token in the plurality of slang tokens and a first sentence comprising the slang token, and the method further comprises, generating the first subset of the plurality of first training data instances by, for each training data instance in the second subset of the plurality of first training data instances: generating, by a large language model (LLM), a plurality of output tokens based on a prompt comprising the first sentence of the respective training data instance comprising the slang token; determining the plurality of output tokens do not comprise the slang token; and determining, by an entailment model, that an entailment score between the definition of the respective training data instance and the plurality of output tokens satisfies a threshold.

Clause 11: The method of any one of Clauses 8-10, wherein masking the at least one token of the plurality of tokens for each training data instance of the plurality of first training data instances to create the plurality of masked training data instances comprises randomly masking at least a first percentage of the plurality of tokens for each first training data instance.

Clause 12: The method of any one of Clauses 8-11, wherein masking the at least one token of the plurality of tokens for each first training data instance of the plurality of first training data instances to create the plurality of masked training data instances comprises masking the at least one slang token included in the plurality of tokens for each first training data instance in the second subset of the plurality of first training data instances.

Clause 13: The method of any one of Clauses 8-12, wherein the ML model comprises an encoder-decoder transformer architecture.

Clause 14: A method of slang detection and mitigation, comprising: receiving an input sentence comprising a plurality of tokens; and processing, with a first machine learning (ML) model trained for slang classification, the input sentence comprising the plurality of tokens and thereby generating at least one of: a first classification output for the input sentence, the first classification output comprising a slang instance classification; or a second classification output for each of the plurality of tokens of the input sentence, at least one second classification output comprising a slang token classification.

Clause 15: The method of Clause 14, further comprising, based on at least one of the first classification output comprising the slang instance classification or the at least one second classification output comprising the slang token classification, processing with a second ML model trained for slang mitigation, the input sentence to generate an output sentence, wherein an entailment score between the input sentence and the output sentence satisfies a threshold, and the output sentence does not comprise any slang tokens.

Clause 16: The method of Clause 15, further comprising using the output sentence to perform one or more tasks.

Clause 17: The method of any one of Clauses 15-16, wherein: the first ML model comprises an encoder only transformer architecture; and the second ML model comprises an encoder-decoder transformer architecture.

Clause 18: The method of any one of Clauses 15-17, further comprising: prior to using the second ML model to process the input sentence to generate the output plurality of tokens: training the second ML model, using a masked-language modeling head, to predict at least one token masked for each of a plurality of masked training data instances, wherein: each training data instance of a first subset of the plurality of masked training data instances does not include at least one slang token of a plurality of slang tokens, and each training data instance of a second subset of the plurality of masked training data instances comprises the at least one slang token of the plurality of slang tokens.

Clause 19: The method of Clause 18, further comprising training the second ML model, using a causal language modeling head, to generate a second output sentence from a second input sentence including the at least one slang token of the plurality of slang tokens.

Clause 20: The method of any one of Clauses 14-19, further comprising: prior to using the first ML model to process the input sentence to generate at least one of the first classification output or the second classification output: training the first ML model, using a masked-language modeling head, to predict at least one token masked for each of a plurality of masked training data instances, wherein: each training data instance of a first subset of the plurality of masked training data instances does not include at least one slang token of a plurality of slang tokens, and each training data instance of a second subset of the plurality of masked training data instances comprises the at least one slang token of the plurality of slang tokens; and training the first ML model, using a classification head and a plurality of non-masked training data instance, to generate an instance-level slang classification or a token-level slang classification.

Clause 21: A processing system, comprising: a memory comprising computer-executable instructions; and a processor configured to execute the computer-executable instructions and cause the processing system to perform a method in accordance with any one of Clauses 1-20.

Clause 22: A processing system, comprising means for performing a method in accordance with any one of Clauses 1-20.

Clause 23: A non-transitory computer-readable medium storing program code for causing a processing system to perform the steps of any one of Clauses 1-20.

Clause 24: A computer program product embodied on a computer-readable storage medium comprising code for performing a method in accordance with any one of Clauses 1-20.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of training a machine learning (ML) model to detect slang usage, comprising:
masking at least one token of a plurality of tokens for each training data instance of a plurality of training data instances to create a plurality of masked training data instances, wherein:
the plurality of tokens for each training data instance in a first subset of the plurality of training data instances does not include at least one slang token of a plurality of slang tokens, and
the plurality of tokens for each training data instance in a second subset of the plurality of training data instances includes the at least one slang token of the plurality of slang tokens;
training the ML model, using a masked-language modeling head, to predict the at least one masked token for each of the plurality of masked training data instances using the plurality of training data instances and the plurality of masked training data instances;
labeling each training data instance of the plurality of training data instances with at least one of a slang instance label, a non-slang instance label, one or more slang token labels, or one or more non-slang token labels to generate a plurality of labeled training data instances; and
training the ML model, using a classification head, to:
classify each training data instance of the plurality of labeled training data instances as one of a slang instance or a non-slang instance and thereby generate a classification output; or
classify each token of the plurality of tokens for each training data instance of the plurality of labeled training data instances as one of a slang token or a non-slang token and thereby generate the classification output.

2. The method of claim 1, wherein:
each training data instance in the first subset of the plurality of training data instances comprises at least a definition associated with a slang token in the plurality of slang tokens, and
the method further comprises generating the second subset of the plurality of training data instances by, for each training data instance in the first subset of the plurality of training data instances:
generating, by a large language model (LLM), a plurality of output tokens based on a prompt comprising the respective training data instance and the slang token associated with the respective training data instance;
determining the plurality of output tokens comprise the slang token; and
determining, by an entailment model, that an entailment score between the definition of the respective training data instance and the plurality of output tokens satisfies a threshold.

3. The method of claim 1, wherein:
each training data instance in the second subset of the plurality of training data instances comprises at least a definition of a slang token in the plurality of slang tokens and a first sentence comprising the slang token, and
the method further comprises, generating the first subset of the plurality of training data instances by, for each training data instance in the second subset of the plurality of training data instances:
generating, by a large language model (LLM), a plurality of output tokens based on a prompt comprising the first sentence of the respective training data instance comprising the slang token;
determining the plurality of output tokens do not comprise the slang token; and
determining, by an entailment model, that an entailment score between the definition of the respective training data instance and the plurality of output tokens or between the first sentence and the plurality of output tokens satisfies a threshold.

4. The method of claim 1, wherein masking the at least one token of the plurality of tokens for each training data instance of the plurality of training data instances to create the plurality of masked training data instances comprises randomly masking at least a first percentage of the plurality of tokens for each training data instance.

5. The method of claim 1, wherein masking the at least one token of the plurality of tokens for each training data instance of the plurality of training data instances to create the plurality of masked training data instances comprises masking the at least one slang token included in the plurality of tokens for each training data instance in the second subset of the plurality of training data instances.

6. The method of claim 1, wherein the ML model comprises an encoder only transformer architecture.

7. The method of claim 6, wherein the encoder only transformer architecture comprises a decoding-enhanced bidirectional encoder representations from transformers with disentangled attention (DeBERTa) model.

8. A method of training a machine learning (ML) model to mitigate slang usage, comprising:
masking at least one token of a plurality of tokens for each first training data instance of a plurality of first training data instances to create a plurality of masked training data instances, wherein:
the plurality of tokens for each first training data instance in a first subset of the plurality of first training data instances does not include at least one slang token of a plurality of slang tokens, and
the plurality of tokens for each first training data instance in a second subset of the plurality of first training data instances includes the at least one slang token of the plurality of slang tokens;
training the ML model, using a masked-language modeling head, to predict the at least one token masked for each of the plurality of masked training data instances using the plurality of first training data instances and the plurality of masked training data instances;
obtaining a plurality of second training data instances, wherein each second training data instance comprises:
a training input comprising a first plurality of tokens including the at least one slang token of the plurality of slang tokens; and
a training output comprising a second plurality of tokens that do not include the at least one slang token of the plurality of slang tokens, wherein an entailment score between the training input and the training output of the respective second training data instance is greater than a threshold; and
for each of the plurality of second training data instances, training the ML model, using a causal language modeling head, to predict the second plurality of tokens from the first plurality of tokens.

9. The method of claim 8, wherein:
each training data instance in the first subset of the plurality of first training data instances comprises at least a definition associated with a slang token in the plurality of slang tokens, and
the method further comprises, generating the second subset of the plurality of first training data instances by, for each training data instance in the first subset of the plurality of first training data instances:
generating, by a large language model (LLM), a plurality of output tokens based on a prompt comprising the respective training data instance and the slang token associated with the respective training data instance;
determining the plurality of output tokens comprise the slang token; and
determining, by an entailment model, that an entailment score between the definition of the respective training data instance and the plurality of output tokens satisfies a threshold.

10. The method of claim 8, wherein:
each training data instance in the second subset of the plurality of first training data instances comprises at least a definition of a slang token in the plurality of slang tokens and a first sentence comprising the slang token, and
the method further comprises, generating the first subset of the plurality of first training data instances by, for each training data instance in the second subset of the plurality of first training data instances:
generating, by a large language model (LLM), a plurality of output tokens based on a prompt comprising the first sentence of the respective training data instance comprising the slang token;
determining the plurality of output tokens do not comprise the slang token; and
determining, by an entailment model, that an entailment score between the definition of the respective training data instance and the plurality of output tokens satisfies a threshold.

11. The method of claim 8, wherein masking the at least one token of the plurality of tokens for each training data instance of the plurality of first training data instances to create the plurality of masked training data instances comprises randomly masking at least a first percentage of the plurality of tokens for each first training data instance.

12. The method of claim 8, wherein masking the at least one token of the plurality of tokens for each first training data instance of the plurality of first training data instances to create the plurality of masked training data instances comprises masking the at least one slang token included in the plurality of tokens for each first training data instance in the second subset of the plurality of first training data instances.

13. The method of claim 8, wherein the ML model comprises an encoder-decoder transformer architecture.

14. A method of slang detection and mitigation, comprising:
receiving an input sentence comprising a plurality of tokens; and
processing, with a first machine learning (ML) model trained for slang classification, the input sentence comprising the plurality of tokens and thereby generating at least one of:
a first classification output for the input sentence, the first classification output comprising a slang instance classification; or
a second classification output for each of the plurality of tokens of the input sentence, at least one second classification output comprising a slang token classification.

15. The method of claim 14, further comprising, based on at least one of the first classification output comprising the slang instance classification or the at least one second classification output comprising the slang token classification, processing with a second ML model trained for slang mitigation, the input sentence to generate an output sentence, wherein:
an entailment score between the input sentence and the output sentence satisfies a threshold, and
the output sentence does not comprise any slang tokens.

16. The method of claim 15, further comprising using the output sentence to perform one or more tasks.

17. The method of claim 15, wherein:
the first ML model comprises an encoder only transformer architecture; and
the second ML model comprises an encoder-decoder transformer architecture.

18. The method of claim 15, further comprising:
prior to using the second ML model to process the input sentence to generate the output sentence:
training the second ML model, using a masked-language modeling head, to predict at least one token masked for each of a plurality of masked training data instances, wherein:
each training data instance of a first subset of the plurality of masked training data instances does not include at least one slang token of a plurality of slang tokens, and
each training data instance of a second subset of the plurality of masked training data instances comprises the at least one slang token of the plurality of slang tokens.

19. The method of claim 18, further comprising training the second ML model, using a causal language modeling head, to generate a second output sentence from a second output sentence including the at least one slang token of the plurality of slang tokens.

20. The method of claim 14, further comprising:
prior to using the first ML model to process the input sentence to generate at least one of the first classification output or the second classification output:
training the first ML model, using a masked-language modeling head, to predict at least one token masked for each of a plurality of masked training data instances, wherein:
each training data instance of a first subset of the plurality of masked training data instances does not include at least one slang token of a plurality of slang tokens, and
each training data instance of a second subset of the plurality of masked training data instances comprises the at least one slang token of the plurality of slang tokens; and
training the first ML model, using a classification head and a plurality of non-masked training data instance, to generate an instance-level slang classification or a token-level slang classification.
